(19) United States
(12) Patent Application Publication
(10) Pub. No.: US 2008/0071005 A1
(43) Pub. Date: Mar. 20, 2008

(54) Environment-Friendly Pollution-Proof Agent

(76) Inventor: Hyun Woung Shin, Chungcheongnam-do (KR)

Correspondence Address: FROMMER LAWRENCE & HAUG, 745 FIFTH AVENUE- 10TH FL., NEW YORK, NY, 10151, US

(21) Appl. No.: 11/629,815

(22) PCT Filed: May 23, 2005
(86) PCT No.: PCT/KR05/01497

§ 371 Date: Sep. 27, 2007

(30) Foreign Application Priority Data
Jun. 18, 2004 (KR) 10-2004-0045533
Jun. 18, 2004 (KR) 10-2004-0045532
Jul. 16, 2004 (KR) 10-2004-0055437
Aug. 23, 2004 (KR) 10-2004-0066306
Aug. 23, 2004 (KR) 10-2004-0066308
Aug. 23, 2004 (KR) 10-2004-0066307

(51) Int. Cl. C09D 5/16

(52) U.S. Cl. 523/122

(57) ABSTRACT

The present invention relates to an environment friendly antifouling agent, and more particularly, to a novel antifouling agent which is harmless to environment, has antifouling activity against a broad spectrum of fouling organisms, can be extracted from nature, resulting in a reduction in production cost than the existing antifouling substances, and can effectively prevent the pollution of marine environment caused by the use of toxic antifouling agents, such as TBT.

### TECHNICAL FIELD

The present invention relates to an environment friendly antifouling agent, and more particularly, to a novel antifouling agent which is harmless to environment, has antifouling activity against a broad spectrum of fouling organisms, can be extracted from nature, resulting in a reduction in production cost than the existing antifouling substances, and can effectively prevent the pollution of marine environment caused by the use of toxic antifouling agents, such as TBT.

### BACKGROUND ART

An antifouling substance refers to a substance which is mixed with paints in order to prevent the fouling of the vessel surface by marine fouling organisms (microorganisms, animals and plants). Fouling means that benthic organisms attach and grow on artificial or natural objects. The attachment of benthic organisms on the vessel surface causes an increase with friction force, resulting in a reduction at the vessel speed, the acceleration of corrosion, and an increase in fuel use leading to economic loss.

It is known that if the bottom of vessels is exposed to seawater for 6 months, fouling organisms will attach on the bottom in an amount of 150 kg/m². It was also reported that, for large-sized vessels, each when the vessel surface roughens at 0.1 mm due to the attachment of fouling organisms, the friction force will be increased by 0.3-1.0%, resulting in a reduction of about 50% at the vessel speed.

In an attempt to solve this problem, organic tin compounds, such as tributyltin (hereinafter, referred to as “TBT”), have been frequently used as antifouling agents. However, as the fact that TBT adversely affects marine environment is found, the Marine Environment Protection Committee (MEPC) of the International Maritime Organization (IMO), which is the UN specialized agency, adopted a resolution of the restriction of antifouling systems for vessels due to the risk of organic tin compounds. As a result, the use of TBT as an antifouling agent was entirely prohibited from Jan. 1, 2003, and a regulation that TBT should be removed from vessels will become effective from the year 2008.

Tin-free antifouling substances, which are currently used as substitutes for organic tin compounds, include cuprous oxide and zinc, as disclosed in Korean patent laid-open publication No. 2001-0099049. The tin-free antifouling agents have a technical problem in that they are insufficient in an antifouling effect against algae, such as green algae. Also, the cuprous oxide antifouling agent also adversely affects environment due to accumulation on the marine bottom, and thus its use will be prohibited between 2006 and 2008. Accordingly, there is an urgent need for the development of an antifouling agent which is excellent in antifouling effect and at the same time, harmless to environment.

Thus, the present inventors have conducted many studies to solve the above-described problems and to develop an antifouling agent which is harmless to environment, excellent in antifouling effect and low in production cost, and consequently, found that substances extracted from plants have excellent antifouling activity, thereby completing the present invention.

### DISCLOSURE OF INVENTION

It is therefore an object of the present invention to provide an antifouling agent which is not only low in production cost since it is extracted from natural materials but also environment friendly.

Another object of the present invention is to provide an environment friendly antifouling paint.

Still another object of the present invention is to provide an environment friendly biocide.

To achieve the above objects, in one aspect, the present invention provides an antifouling agent containing as active ingredients at least one compounds selected from the following compounds: at least one ketone compounds selected from the group consisting of 3,7-dimethyl-2,6-octadienal, cis-3-hexenyl acetate, acetophenone, arachadic acid, methyl caporate, and ethyl heptanoate; at least one vinyl compounds selected from the group consisting of allyl isothiocyanate, beta-myrcene, and eugenol; and at least one alcohol compound selected from the group consisting of 1-octadecanol and 1-octanol.

In another aspect, the present invention provides an antifouling paint comprising a resin, a solvent, a pigment, an antifouling substance and other additives, in which the antifouling substance is one or a mixture of two or mixture selected from the following compounds: at least one ketone compounds selected from the group consisting of 3,7-dimethyl-2,6-octadienal, cis-3-hexenyl acetate, acetophenone, arachadic acid, methyl caporate and ethyl heptanoate; at least one vinyl compounds selected from the group consisting of allyl isothiocyanate, beta-myrcene and eugenol; and at least one alcohol compound selected from the group consisting of 1-octadecanol and 1-octanol.

Also, the above-described compounds can be used as not only antifouling agents but also biocides since they have an algae inhibitory effect and an antibiotic effect. Thus, these antifouling agents and biocides are within the scope of the present invention.

Hereinafter, the present invention will be described in more detail.

The present invention relates to a novel antifouling agent which is harmless to environment, has antifouling activity against a broad spectrum of fouling organisms, can be extracted from nature, resulting in a reduction in production cost than the existing antifouling substances, and can effectively prevent the pollution of marine environment caused by the use of toxic antifouling agents, such as TBT.

In order to develop an environmentally harmless antifouling paint, the present inventors have tested the antifouling activity of various kinds of seaweeds and land plants. For use as the seaweeds, species inhibited in the intertidal of various areas of the Korean east and south coasts and species collected by diving were screened, identified, dried in the shade, and crushed with a crusher, and the powder sample was stored in a glass bottle and used when required. For use as the land plants, among land plants inhibited throughout Korea, plants whose secondary metabolic products are known to be able to have antifouling activity by literature information were collected, screened, identified, dried in the shade, crushed with a crusher, and extracted.

The effect of the extracts on the prevention of the attachment of fouling algae was tested using the spores of Enteromorpha prolifera and Ulva pertusa, which are typical fouling algae. In the test, the following compounds among various algae and land plants showed excellent antifouling activity: 3,7-dimethyl-2,6-octadienal, cis-3-hexenyl acetate, acetophenone, arachadic acid, methyl caporate, ethyl heptanoate, allyl isothiocyanate, beta-myrcene, eugenol, 1-octadecanol and 1-octanol.

Meanwhile, an antifouling paint generally comprises an antifouling substance, a resin, a solvent, a pigment, other additives and the like, and may also contain a booster for improving antifouling activity.

The paint according to the present invention contains the antifouling substance in an amount of 3-40% by weight, and preferably 10-30% by weight. If the content of the antifouling substance is less than 3% by weight, the paint will be insufficient in antifouling activity, and if the content of the antifouling substance is more than 30% by weight, the mixing properties with other components, and long-term storage properties will be deteriorated.

Resins which can be used in the inventive antifouling paint include all resins used in the prior antifouling paints. Examples thereof include vinyl resins, such as vinyl acetate and vinyl chloride resins, synthetic resins, such as urethane, rubber chloride, phthalic acid, alkid, epoxy, phenol, melamine, acrylic, fluorine and silicon resins, and natural resins, such as rosin. Particularly, the acrylic resin is a polymer containing at least one monomers selected from, for example, w-(N-isothiazolonyl)alkyl acrylate, w-(N-isothiazolonyl)alkyl methacrylate, w-(N-4-chloroisothiazolonyl)alkyl acrylate, w-(N-4-chloroisothiazolonyl)alkyl methacrylate, w-(N-5-chloroisothiazolonyl)alkyl acrylate, w-(N-5-chloroisothiazolonyl)alkyl methacrylate, w-(N-4,5-dichloroisothiazolonyl)alkyl acrylate, w-(N-4,5-dichloroisothiazolonyl)alkyl methacrylate, w-maleimidoalkyl acrylate, w-maleimidoalkyl methacrylate, w-2,3-maleimidoalkyl acrylate, w-2,3-dichloromaleimidoalkyl methacrylate, w-maleimidoalkyl vinyl ether, 4-maleimidoalykl acrylate, acrylic acid, methacrylic acid, maleic anhydride, hydroxylalkyl acrylate, alkoxyalkyl acrylate, phenoxyalkyl acrylate, w-(acetoacetoxy)alkyl acrylate, w-(acetoacetoxy)alkyl acrylate, w-(acetoacetoxy)alkyl vinyl ether, vinyl acetoacetoacetate, N,N′-dialkylacrylate, vinylpyridine, vinylpyrrolidone, 4-nitrophenyl-2-vinyl ethylate, 2,4-dinitrophenyl acrylate, 2,4-dinitrophenyl methacrylate, 4-thiocyanophenyl acrylate, trialkylsilyl acrylate, monoalkyldiphenylsilyl acrylate, dichloromethyl acrylate, chloromethyl methacrylate, phenylmethyl acrylate, diphenylmethyl acrylate, diphenylmethyl methacrylate, zinc trialkyl acrylate, zinc triakyl methacrylate, zinc triaryl acrylate, zinc triaryl methacrylate, copper trialkyl acrylate, copper trialkyl methacrylate, copper triaryl acrylate, and copper triaryl methacrylate. A preparation method of this polymer is well described in Korean patent application No. 95-15149. The number-average molecular weight of the polymer is preferably in a range of 1,500-100,000 in view of viscosity, film formation ability and workability. Moreover, the synthetic resin may also be used in combination with the natural resin. The content of the resin in the paint is 2-20% by weight, and preferably 5-15% by weight. If the resin content is less than 2% by weight, the adhesion of the paint will be reduced, and if the content is more than 20% by weight, the paint will have a problem in storage properties.

Solvents which can be used in the inventive antifouling paint include hydrocarbon and ketone solvents, such as xylene, methylethylketone and methylisobutylketone, and cellosolve acetate, and preferably used in an amount of 10-30% by weight. If the solvent content is less than 10% by weight, the paint will have excessively high viscosity, and if the solvent content is more than 30% by weight, the paint will have problems in adhesion and antifouling activity.

Pigments which can be used in the inventive antifouling paint include various pigments known in the art. For example, metal oxides, such as titanium oxide, iron oxide and zinc oxide, and organic pigments, may be used alone or in a mixture. The pigment is preferably used in an amount of 20-40% by weight. If the pigment is used in an amount of less than 20% by weight, the problem of discoloration will occur, and if it is used in an amount of more than 40% by weight, the weather resistance of the paint will be deteriorated.

If the antifouling activity of the paint needs to be further improved, a booster can be used. Examples thereof include zinc pyrithione, copper pyrithione, polyhexamethyleneguanidine phosphate, 2,4,5,6-terachloroisophthalonitrile, 3-(3,4-dichlorophenyl)-1,1-dimethylurea, 2-methylthio-4-terbutylamino-6-cyclopropylamino-s-triazine, zinc ethylenebisdithiocarbamate, manganese ethylenebisdithiocarbamate, 2-n-octyl-4,5-dichloro-2-methyl-4-isothiazoline-3-one, 2-(thiocyanomethylthio)benzothiazole, 2,3,5,6-tetrachloro-4-(methylsulphonyl)pyridine, 3-iodo-2-propynyl butylcarbamate, diiodomethyl-p-tolylsulfone, 1,2-benzoisothiazolin-3-one, 2-methylthio-4-tert-butylamino-6-cyclopropylamino-s-triazine, 2-(4-thiocyanomethylthio)benzothiazole), 2-n-octyl-4-isothiazolin-3-one, N-(fluorodichloromethylthio)-phthalimide, N-dichlorofluoromethylthio-N′,N′-dimethyl-N-p-tolylsulfamide, N,N-dimethyl-N′-phenyl-(fluorodichloromethylthio)-sulphamide, zinc(2-pyridylthio-1-oxide), copper(2-pyridylthio-1-oxide), and silver compounds. These compounds may be used alone or a mixture of two or more. The booster is preferably used in an amount of 1-7% by weight, and more preferably 2-4% by weight. If the booster content is used in an amount of less than 1%, its effect on an increase in antifouling activity will be insignificant, and if it is used in an amount of more than 7%, the paint will have a problem in storage stability.

In addition, the inventive paint composition may also contain various known additives. Examples of the additives may include thickeners, such as polyamide wax, bentonite or polyethylene wax. These additives are preferably used in an amount of 1-5% by weight. If the content of the additives is more than 5% by weight, the viscosity of the paint will be excessively increased.

Furthermore, at least one compounds selected from the following compounds may also be used in biocides since they have algal movement inhibitory activity and antibiotic activity: at least one ketone compounds selected from the group consisting of 3,7-dimethyl-2,6-octadienal, cis-3-hexenyl acetate, acetophenone, arachadic acid, methyl caporate and ethyl heptanoate; at least one vinyl compounds selected from the group consisting of allyl isothiocyanate, beta-myrcene and eugenol; and at least one alcohol compound selected from the group consisting of 1-octadecanol and 1-octanol. The biocide may preferably contain as active ingredients the inventive extracts or compounds in an amount of 0.1-5% by weight based on the total weight of the biocide. In addition to the active ingredients, the biocide may also contain a surfactant, a solvent, and an isothiazolone biocide.

### BRIEF DESCRIPTION OF DRAWINGS

FIG. 1 is a graphic diagram showing the inhibitory effect of Dioscorea batatas solvent fractions F1-F6 against the settlement of spores.

FIG. 2 shows GC-MS results for 3,7-dimethyl-2,6-octadienal.

FIG. 3 shows NMR data for 3,7-dimethyl-2,6-octadienal.

FIG. 4 shows GC-MS results for cis-3-hexenyl acetate.

FIG. 5 shows NMR data for cis-3-hexenyl acetate.

FIG. 6 shows the HPLC profile of Dioscorea batatas-derived fraction F2.

FIG. 7 shows the HPLC profile of Dioscorea batatas-derived fraction F5.

FIG. 8 shows GC-MS results for acetophenone.

FIG. 9 shows GC-MS results for 1-octadecanol and arachadic acid.

FIG. 10 shows the profile of ¹³C NMR spectrum of acetophenone.

FIG. 11 shows the profile of ¹H NMR spectrum of acetophenone.

FIG. 12 shows the two-dimensional NMR spectrum of acetophenone.

FIG. 13 shows the profile of ¹³C NMR spectra of 1-octadecanol and arachadic acid.

FIG. 14 shows the profile of ¹H NMR spectra of 1-octadecanol and arachadic acid.

FIG. 15 shows the two-dimensional NMR spectra of 1-octadecanol and arachadic acid.

FIG. 16 shows the profile of ¹³C NMR spectrum of allyl isothiocyanate.

FIG. 17 shows the ¹H NMR spectrum of allyl isothiocyanate.

FIG. 18 shows the profile of ¹³C NMR spectrum of 1-octanol.

FIG. 19 shows the profile of ¹H NMR spectrum of 1-octanol.

FIG. 20 shows the profile of ³C NMR spectrum of methyl carporate.

FIG. 21 shows the profile of ¹H NMR spectrum of methyl carporate.

FIG. 22 shows the profile of ¹³C NMR spectrum of ethyl heptanoate.

FIG. 23 shows the profile of ¹H NMR spectrum of ethyl heptanoate.

FIG. 24 shows the profile of ¹³C NMR spectrum of beta-Myrcene.

FIG. 25 shows the profile of ¹H NMR spectrum of beta-Myrcene.

FIG. 26 shows the profile of ¹³C NMR spectrum of eugenol.

FIG. 27 shows the profile of ¹H NMR spectrum of eugenol.

### BEST MODE FOR CARRYING OUT THE INVENTION

The present invention will hereinafter be described in further detail by examples. It will however be obvious to a person skilled in the art that the present invention is not limited to or by these examples.

### EXAMPLE 1

### Sample Collection and Extraction

1) Extraction of Citrus sp.

In order to test a attachment inhibitory effect against shellfishes, typical fouling shellfish Mytilus edulis was selected and tested using a foot-stimulating method. In the foot-stimulating method, the adductor muscle of Mytilus edulis was removed and immersed in seawater for 5-10 minutes. Then, the shells opened and 10 μl of seawater was dropped on the adductor muscle of Mytilus edulis. Individuals showing a contractile response to the seawater were excluded, and 10 μl of each of organism-derived extracts was dropped on the adductor muscle at varying concentrations, and the contraction or non-contraction of the adductor muscle was examined.

1 μl methyl alcohol/EA was found to have no effect on the contraction of the adductor muscle, and 1 μl (40 mg/ml) of each extract was dissolved in 10 μl of sterilized seawater to a final concentration of 40 μg/ml.

The muscle contractile activity was expressed as percentage by dividing the number of individuals showing a contractile response by the total number of individuals. In the test, planted individuals of 4.5±0.2 cm were selected and the resting time of the sea mussels was 5 minutes. The test was repeated three times, the statistical analysis of the test results was performed by Student's t-test. As a result, aqueous extracts generally showed a lower effect than that of methyl alcohol extracts, and as shown in Table 1 below, Citrus sp. showed an excellent inhibitory effect of more than 90% against the attachment of Mytilus edulis.

TABLE 1

| | Reactivity (%) | |
|---|---|---|
| | Methanol extracts | Water extract |
| Species | (200 mg/ml) | (200 mg/ml) |
| Citrus sp. | 92 ± 4 | 12 ± 1 |
| Robinia pseudo-accacia L. | 18 ± 2 | 32 ± 1 |
| Lespedeza bicolor Turcz | 16 ± 1 | 20 ± 2 |
| Salix spp. | 22 ± 2 | 22 ± 1 |
| Commelina communis L. | 0 | 26 ± 2 |
| Artemisia princeps Pampan | 26 ± 2 | 30 ± 1 |
| Agrimonia pilosa Ledeb | 70 ± 3 | 6 ± 1 |
| Pueraria thunbergiana Benth | 38 ± 2 | 14 ± 1 |
| Achyranthus Japonica (Miq) Nakai | 14 ± 1 | 0 |
| Salix spp. | 20 ± 1 | 30 ± 1 |
| Quercus aliera B1. | 30 ± 1 | 22 ± 1 |
| Euonymus alatus (Thumb.) Seieb. | 32 ± 2 | 4 |
| Chelidonium majus var. asiaticum | 70 ± 1 | 16 ± 1 |
| Viburnum dilatatum Thunb. | 18 ± 4 | 12 ± 1 |
| Ailanthus altissima Swingle | 14 ± 5 | 10 ± 1 |
| Elaeagnus umbellata Thumb. | 24 ± 1 | 0 |
| Euonymus spp. | 32 ± 2 | 4 |
| Dioscorea japonica Thumb. | 50 ± 6 | 22 ± 1 |
| Rumex chispus L. | 70 ± 3 | 10 ± 2 |
| Bidens frondosa L. | 8 ± 1 | 8 ± 1 |
| Gypsophila oldhamiana Miq. | 6 ± 1 | 4 |
| Persicaria nodosa Opiz | 12 ± 1 | 20 ± 1 |
| Commelina communis L. | 70 ± 2 | 22 ± 1 |
| Quercus serrata Thumb. | 24 ± 5 | 14 ± 2 |
| Acer ginnala Max. | 28 ± 6 | 16 ± 1 |
| Kochia scoparia Schrad. | 30 ± 3 | 22 ± 1 |
| Lindera obtusiloba Bl. | 34 ± 4 | 20 ± 3 |
| Juncus effusus var. decipoens | 36 ± 1 | 16 ± 2 |
| Buchen | | |
| Rubus crataegifolius Bunge | 34 ± 5 | 18 ± 2 |
| Oenothera ochrata Jacq | 32 ± 2 | 4 ± 1 |
| Boehmeria platanifolia | 28 ± 6 | 10 ± 1 |
| Cornus conteroversn Hemsl | 10 ± 2 | 12 ± 2 |
| Lespedeza cuneata G. Don | 18 ± 5 | 10 ± 1 |
| Rubus crataegifolius Bunge | 4 ± 3 | 22 ± 1 |
| Rumex crispus | 22 ± 5 | 20 ± 2 |
| Patrinia scabiosaefolia Fisch | 20 ± 2 | 34 ± 2 |

2) Extraction of Brassica sp.

The inhibitory effect of organism-derived extracts against the attachment of spore of Enteromorpha prolifera was tested. Each of methyl alcohol extracts of samples was tested for attachment inhibitory effect at a concentration of 200 μl/ml, and as a result, an extract of Brassica sp. showed an excellent inhibitory effect against the attachment of spores (see Table 2a, 2b).

TABLE 2a

| | Spore atttachment (%) | |
|---|---|---|
| | Methanol extracts | Water extracts |
| Species | (200 mg/ml) | (200 mg/ml) |
| Lomentaria catenata | 86 ± 7 | 79 ± 4 |
| Sargassum confusum | 75 ± 4 | 78 ± 5 |
| Identifying | 85 ± 7 | 85 ± 9 |
| Laminaria sp. | 77 ± 8 | 84 ± 5 |
| Sargassum thunbergii | 55 ± 9 | 76 ± 8 |
| Sargassum fulvellum | 45 ± 11 | 87 ± 4 |
| Ishige okamurai | 85 ± 8 | 85 ± 4 |
| Sargassum sp. | 86 ± 9 | 88 ± 6 |
| Sargassum sp. | 69 ± 9 | 84 ± 6 |
| Sargassum sp. (139) | 21 ± 5* | 84 ± 5 |
| Sargassum sp. | 72 ± 7 | 71 ± 9 |
| Sargassum sp. ringggoidianum | 79 ± 6 | 79 ± 3 |
| Identifying | 78 ± 8 | 107 ± 6 |
| Ecklonia kurome | 54 ± 5 | 95 ± 7 |
| Identifying | 86 ± 6 | 81 ± 7 |
| Identifying | 95 ± 2 | 78 ± 8 |
| Sargassum filicinum | 72 ± 7 | 71 ± 8 |
| Sargassum filicinum | 91 ± 8 | 86 ± 9 |
| Identifying | 87 ± 4 | 95 ± 8 |
| Ishige okamurai | 92 ± 6 | 76 ± 6 |
| Gelidium amansii | 88 ± 4 | 95 ± 5 |
| Chondria crassiculis | 88 ± 6 | 71 ± 6 |
| Sargassum thunbergii | 88 ± 3 | 85 ± 2 |
| Chondrus ocellatus | 81 ± 4 | 85 ± 2 |
| Sargassum sp. | 48 ± 6 | 96 ± 8 |
| Sargassum sp. | 76 ± 8 | 74 ± 9 |
| Sargassum horneri | 85 ± 2 | 94 ± 6 |
| Pachymeniopsis elliptica | 94 ± 1 | 78 ± 8 |
| Gelidium amansii | 70 ± 7 | 86 ± 8 |
| Identifying | 69 ± 3 | 84 ± 6 |
| Gracilaria verrucosa | 81 ± 8 | 87 ± 7 |
| Identifying | 86 ± 4 | 73 ± 8 |
| Identifying | 77 ± 6 | 79 ± 10 |
| Grateloupia filicina | 95 ± 5 | 87 ± 4 |

TABLE 2b

| | Spore attachment (%) | |
|---|---|---|
| | Methanol extracts | Water extracts |
| Species | (200 mg/ml) | (200 mg/ml) |
| Gelidium amansii | 91 ± 7 | 94 ± 8 |
| Identifying | 74 ± 9 | 86 ± 5 |
| Pachymeniopsis sp. | 83 ± 8 | 93 ± 6 |
| Chondrus ocellatus | 89 ± 2 | 89 ± 9 |
| Ecklonia cava | 87 ± 4 | 79 ± 7 |
| Grateloupia sp. | 85 ± 7 | 77 ± 4 |
| Lomentaria catenata | 87 ± 11 | 85 ± 7 |
| Corallina sp. | 77 ± 6 | 95 ± 5 |
| Gymnogongrus flabelliformis | 74 ± 5 | 96 ± 8 |
| Gelidium amansii | 74 ± 5 | 86 ± 8 |
| Identifying | 68 ± 6 | 89 ± 6 |
| Identifying | 89 ± 5 | 87 ± 7 |
| Sargassum horneri | 95 ± 4 | 92 ± 2 |
| Ulva pertusa | 92 ± 8 | 85 ± 2 |
| Identifying | 81 ± 9 | 91 ± 3 |
| Identifying | 79 ± 1 | 64 ± 8 |
| Sargassum sp. | 64 ± 3 | 69 ± 9 |
| Sargassum sp. | 78 ± 5 | 86 ± 4 |
| Agarum cribrosum | 91 ± 7 | 85 ± 7 |
| Sargassum horneri | 93 ± 8 | 94 ± 8 |
| Identifying | 91 ± 8 | 92 ± 9 |
| Identifying | 89 ± 8 | 76 ± 9 |
| Chondrus ocellatus | 85 ± 9 | 75 ± 5 |
| Carpopeltis cornea | 77 ± 6 | 86 ± 4 |
| Chondrus sp. | 60 ± 4 | 74 ± 7 |
| Codium sp. | 91 ± 4 | 72 ± 8 |
| Pachymeniopsi lanceolata | 92 ± 4 | 84 ± 9 |
| Chondrus sp. | 95 ± 2 | 78 ± 6 |
| Identifying | 84 ± 7 | 77 ± 6 |
| Sargassum sp. | 96 ± 4 | 92 ± 3 |
| Pachymeniopsi lanceolata | 79 ± 4 | 84 ± 2 |
| Ulva sp. | 85 ± 8 | 74 ± 5 |
| Carpopeltis cornea | 88 ± 9 | 69 ± 8 |
| Sargassum sp. (365) | 31 ± 9* | 82 ± 5 |
| Grateloupia okamurai | 24 ± 9* | 94 ± 4 |
| Sargassum sp. (383) | 31 ± 4* | 86 ± 3 |
| Brassica sp. | 30 ± 6* | 78 ± 9 |
| Chaetomorpha aerea | 78 ± 8 | 64 ± 6 |
| Sargassum sp. | 51 ± 7 | 54 ± 8 |

3) Extraction of D. batatas

D. batatas was collected in Andong, Janyang and Youngpung, Korea, and foreign materials were removed from the plant. Then, the plant was washed, dried in the shade and crushed to make 30 kg of D. batatas powder. 30 kg of the sample powder was added to 50 liters of methanol, stored for 24 hours and extracted, and only the supernatant was collected. The extraction and supernatant collection procedures were repeated three times, and the supernatants were combined together, and then, evaporated to a volume of 1/10 with a vacuum concentrator at 37° C. The remaining material was filtered through a 0.22-(m filter and used in tests with storage at −20° C.

4) Plant Extraction

Mustard leaves used in tests were collected in Pyongchang-gun, Kangwon-do, Korea, and lemons and blueberries were collected in boseong-gun, Jeollanam-do, Korea. Foreign materials were removed from the collected land plants. Then, the plants were washed and dried in the shade. In order to increase extraction yield, the land plants were powdered with a crusher and used in tests. The collected land plants were dried in the shade and crushed to make 1 kg of each of mustard leaf powder, lemon powder and blueberry powder. Each of 1 kg of the sample powders was added to 10 liters of methanol, stored for 24 hours and extracted. The extraction and supernatant collection procedures were repeated three times, and the supernatants were combined together, and then, evaporated to a volume of 1/10 with a vacuum concentrator at 37 (C. The remaining material was filtered through a 0.22-(m filter and used in tests with storage at −20 (C.

### EXAMPLE 2

### Solvent fractionation of Citrus sp. extract

In order to investigate inhibitory substances against the mobility of Enteromorpha spores from extracts of Citrus sp., organic solvent fractions were made.

Citrus sp. was extracted with each of hexane, methyl alcohol and water. The hexane and methyl alcohol extracts were filtered and the filtrates were concentrated with a vacuum concentrator at 30 (C. The water extract was freeze-dried with a freeze dryer.

Each of the extracts was tested for physiological activity, and the results are shown in Table 3 below. In the results of an inhibitory activity test against the mobility of Enteromorpha spores, the hexane extract showed powerful inhibitory effect (inhibition of more than 95%: ++++) at 10,000 μg/ml, 7,500 μg/ml and 5,000 μg/ml, strong activity (95-75%: +++) at 2,500 μg/ml, and moderate activity (75-50%: ++) at 1,250 (g/ml (75-50%: ++).

The methyl alcohol extract showed strong activity (+++) at 10,000 (g/ml and 75,000 (g/ml, but no activity at 1,250 (g/ml. Also, the water extract showed moderate activity (++) at 10,000 (g/ml and 7,500 (g/ml, weak activity at 5,000 (g/ml, and no activity at 2,500 (g/ml and 1,250 (g/ml.

As a result, the hexane extract showed an excellent effect, and thus, used as a sample for the isolation and purification of antifouling components.

TABLE 3

| | Activity | | |
|---|---|---|---|
| Concentration ((g/ml) | n-hexane | Methyl alcohol | Water |
| 10,000 | ++++ | +++ | ++ |
| 7,500 | ++++ | +++ | ++ |
| 5,000 | ++++ | ++ | + |
| 2,500 | +++ | + | − |
| 1,250 | ++ | − | − |

First Silica Gel Column Chromatography

A column was packed with silica gel (70-230 meshes) in hexane. The hexane extract sample was applied to the column, and the column was eluted sequentially with hexane (10), hexane:methylene chloride (7.5:2.5), hexane:methylene chloride (5:5), hexane:methylene chloride (2.5:7.5), methylene chloride (10), methylene chloride:ethylene acetate (8:2), methylene chloride:ethyl acetate (6:4), methylene chloride:ethyl acetate (4:6), methylene chloride:ethyl acetate (2:8), ethyl acetate (10), ethyl acetate:methyl alcohol (9:1), ethyl acetate:methyl alcohol (8:2), ethyl acetate:methyl alcohol (7:3), ethyl acetate:methyl alcohol (5:5), and methyl alcohol (10). These extraction solvents were passed through the column in a volume of 100 ml for the extraction solvents from hexane to methylene chloride, and in a volume of 300 ml for the extraction solvents from methylene chloride (8:2) to methyl alcohol, at a flow rate of 3 ml/min (see Table 4).

TABLE 4

| Extraction solvents | Volume (ml) |
|---|---|
| Hexane (10) | 100 |
| Hexane:methylene chloride (7.5:2.5) | 100 |
| Hexane:methylene chloride (5:5) | 100 |
| Hexane:methylene chloride (2.5:7.5) | 100 |
| Methylene chloride (10) | 100 |
| Methylene chloride:ethyl acetate (8:2) | 300 |
| Methylene chloride:ethyl acetate (6:4) | 300 |
| Methylene chloride:ethyl acetate (4:6) | 300 |
| Methylene chloride:ethyl acetate (2:8) | 300 |
| Ethyl acetate (10) | 300 |
| Ethyl acetate:methyl alcohol (9:1) | 300 |
| Ethyl acetate:methyl alcohol (8:2) | 300 |
| Ethyl acetate:methyl alcohol (7:3) | 300 |
| Ethyl acetate:methyl alcohol (6:4) | 300 |
| Ethyl acetate:methyl alcohol (5:5) | 300 |
| Methyl alcohol (10) | 300 |

The eluates were fractionated into six fractions by performing TLC in a mixed solvent of hexane:methylene chloride:ethyl acetate (3:1:1). The six fractions (I-VI) were tested for physiological activity, and the results are shown in Table 5 below.

TABLE 5

| Concentration | Activity | | | | | |
|---|---|---|---|---|---|---|
| (μg/ml) | I | II | III | IV | V | VI |
| 4,000 | ++ | +++ | +++ | +++ | ++++ | +++ |
| 2,000 | ++ | ++ | +++ | +++ | ++++ | ++ |
| 1,500 | ++ | + | ++ | +++ | ++++ | ++ |
| 1,000 | + | + | ++ | ++ | ++++ | ++ |
| 750 | − | + | ++ | ++ | +++ | ++ |
| 250 | − | + | + | + | +++ | + |

At a concentration of 4,000 μg/ml, the fraction V showed powerful inhibitory activity (++++) against the mobility of spores, and the fractions II, III, IV and VI showed strong activity (+++). At 2,000 μg/ml and 1,500 μg/ml, the fraction V showed powerful activity (++++), and at 750 μg/ml and 250 μg/ml, it showed a reduction in activity but maintained strong activity (+++).

As a result, the fraction V within the range of methylene chloride:ethyl acetate (2:8), which shows the most excellent activity among the fractions I-VI, was used as a sample for the isolation and purification of antifouling components by the second silica gel column chromatography.

Second Silica Gel Column Chromatography

A column was packed with silica gel (70-230 meshes) in hexane. The fraction V as a sample was applied to the column, and the column was eluted sequentially with hexane (10), hexane:methylene chloride (9:1), hexane:methylene chloride (8:2), hexane:methylene chloride (7:3), hexane:methylene chloride (6:4), hexane:methylene chloride (5:5), hexane:methylene chloride (4:6), hexane:methylene chloride (3:7), hexane:methylene chloride (2:8), hexane:methylene chloride (1:9), methylene chloride (10), methylene chloride:ethyl acetate (9:1), methylene chloride:ethyl acetate (8:2), methylene chloride:ethyl acetate (7:3), methylene chloride:ethyl acetate (6:4), methylene chloride:ethyl acetate (5:5), methylene chloride:ethyl acetate (4:6), methylene chloride:ethyl acetate (3:7), methylene chloride:ethyl acetate (2:8), methylene chloride:ethyl acetate (1:9), ethyl acetate (10), ethyl acetate:methyl alcohol (9:1), ethyl acetate:methyl alcohol (8:2), ethyl acetate:methyl alcohol (7:3), ethyl acetate:methyl alcohol (6:4), ethyl acetate:methyl alcohol (5:5), and methyl alcohol (10). Each of these extraction solvents was passed through the column in a volume of 100 ml at a flow rate of 3 ml/min (see Table 6). Then, each of eluates was subjected to TLC in a mixed solvent of hexane:methylene:ethyl acetate (3:1:1) so as to make six fractions (V-i to V-vi). The six fractions were tested for inhibitory activity against the mobility of spores, and the results are shown in Table 7 below.

TABLE 6

| Extraction solvent | Volume (ml) |
|---|---|
| Hexane (10) | 100 |
| Hexane:methylene chloride (9:1) | 100 |
| Hexane:methylene chloride (8:2) | 100 |
| Hexane:methylene chloride (7:3) | 100 |
| Hexane:methylene chloride (6:4) | 100 |
| Hexane:methylene chloride (5:5) | 100 |
| Hexane:methylene chloride (4:6) | 100 |
| Hexane:methylene chloride (3:7) | 100 |
| Hexane:methylene chloride (2:8) | 100 |
| Hexane:methylene chloride (1:9) | 100 |
| Methylene chloride (10) | 100 |
| Methylene chloride:ethyl acetate (9:1) | 100 |
| Methylene chloride:ethyl acetate (8:2) | 100 |
| Methylene chloride:ethyl acetate (7:3) | 100 |
| Methylene chloride:ethyl acetate (6:4) | 100 |
| Methylene chloride:ethyl acetate (5:5) | 100 |
| Methylene chloride:ethyl acetate (4:6) | 100 |
| Methylene chloride:ethyl acetate (3:7) | 100 |
| Methylene chloride:ethyl acetate (2:8) | 100 |
| Methylene chloride:ethyl acetate (1:9) | 100 |
| Ethyl acetate (10) | 100 |
| Ethyl acetate:methyl alcohol (9:1) | 100 |
| Ethyl acetate:methyl alcohol (8:2) | 100 |
| Ethyl acetate:methyl alcohol (7:3) | 100 |
| Ethyl acetate:methyl alcohol (6:4) | 100 |
| Ethyl acetate:methyl alcohol (5:5) | 100 |
| Methyl alcohol (10) | 100 |

TABLE 7

| Concentration | Activity | | | | | |
|---|---|---|---|---|---|---|
| (μg/ml) | V-i | V-ii | Viii | V-iv | V-v | V-vi |
| 4,000 | ++ | ++++ | ++++ | ++++ | ++++ | ++ |
| 2,000 | ++ | +++ | ++++ | ++++ | ++++ | ++ |
| 1,500 | ++ | ++ | ++++ | ++++ | +++ | ++ |
| 1,000 | + | ++ | ++++ | +++ | +++ | + |
| 750 | + | ++ | ++++ | +++ | +++ | + |
| 500 | + | + | ++++ | ++ | ++ | − |
| 375 | + | + | +++ | ++ | ++ | − |
| 250 | − | + | +++ | + | + | − |

As a result, the fraction V-iii showed the most excellent activity, and thus, was used as a sample for the isolation and purification of antifouling components by Prep-TLC.

The fraction V-iii showing the most excellent activity in the physiological activity test of the fractions obtained by performing the concentration gradient of the organic solvents by the second silica gel column chromatography was developed on Prep-TLC with the use of a mixed solvent of hexane:methylene chloride:ethyl acetate (3:1:1) to obtain three fractions, i.e., V-iii-a, V-iii-b and V-iii-c.

The inhibitory effect of the three fractions against the mobility of Enteromorpha spores is shown in Table 8 below.

TABLE 8

| | Activity | | |
|---|---|---|---|
| Concentration (μg/ml) | V-iii-a | V-iii-b | V-iii-c |
| 4,000 | ++++ | ++++ | ++++ |
| 2,000 | +++ | +++ | +++ |
| 1,500 | +++ | +++ | +++ |
| 1,000 | ++ | +++ | ++ |
| 750 | ++ | +++ | ++ |
| 500 | ++ | ++ | ++ |

As a result, the fraction V-iii-b maintained activity despite an increase in dilution rate, and thus, was used as a sample for the isolation and purification of antifouling components by Prep-HPLC.

Prep-HPLC

The active fraction V-iii-b obtained in Prep-TLC was applied to a Prep-HPLC C18 reversed phase column (Microsorb, 21.4×250 mm). The mobile phase was eluted with a mixed solvent of 60% acetonitrile and 40% water for 120 minutes at a flow rate of 20 ml/min. The absorbance at 213 nm was measured while collecting six fractions (K1-K6) showing the peak absorbance.

Each of the fractions (K1-K6) collected from the Prep-HPLC of the active fraction V-iii-b obtained from Prep-TLC was tested for the inhibitory activity of mobility of Enteromorpha spores, and the results are shown in Table 9 below.

TABLE 9

| Concentration | Activity | | | | | |
|---|---|---|---|---|---|---|
| ((g/ml) | K1 | K2 | K3 | K4 | K5 | K6 |
| 4,000 | | +++ | ++++ | ++++ | ++++ | ++++ |
| 2,000 | ++ | +++ | ++++ | ++++ | ++++ | ++++ |
| 1,500 | ++ | ++ | ++++ | ++++ | ++++ | +++ |
| 1,000 | + | ++ | ++++ | ++++ | ++++ | +++ |
| 500 | + | ++ | +++ | ++++ | +++ | ++ |
| 250 | − | + | +++ | ++++ | ++ | + |
| 125 | − | + | ++ | ++++ | ++ | + |
| 62.5 | − | − | ++ | +++ | + | + |

As a result, the fraction K4 was most excellent in an inhibitory effect against the mobility of Enteromorpha spores among the six collected fractions (K1-K6), and thus, was used as a sample for structural analysis by GC-MS, LC-MS and NMR.

### EXAMPLE 3

### Solvent Fractionation of brassica Extract

In order to investigate inhibitory substances against the mobility of Enteromorpha spores from extracts of brassica, organic solvent fractions were made.

Brassica powder was extracted with each of hexane, methyl alcohol and water. The hexane and methyl alcohol extracts were filtered and the filtrates were concentrated with a vacuum concentrator at 30° C., and the water extract was freeze-dried with a freeze-dryer.

Each of the solvent extracts was tested for physiological activity, and the results are shown in Table 10 below. In the results of inhibitory activity test against the mobility of Enteromorpha spores, the hexane extract showed powerful inhibitory effect (inhibition of more than 95%: ++++) at 10,000 μg/ml, 7,500 μg/ml and 5,000 μg/ml, strong activity (95-75%: +++) at 2,500 μg/ml and moderate activity (75-50%: ++) at 1,250 μg/ml.

The methyl alcohol extract showed strong activity (+++) at 10,000 (g/ml and 75,000 (g/ml, but no activity at 1,250 (g/ml. Also, the water extract showed moderate activity (++) at 10,000 (g/ml and 7,500 (g/ml, weak activity at 5,000 (g/ml, and no activity at 2,500 (g/ml and 1,250 (g/ml.

As a result, the hexane extract showed an excellent effect, and thus, was used as a sample for the isolation and purification of antifouling components.

TABLE 10

| | Activity | | |
|---|---|---|---|
| Concentration ((g/ml) | n-hexane | Methyl alcohol | Water |
| 10,000 | ++++ | +++ | ++ |
| 7,500 | ++++ | +++ | ++ |
| 5,000 | ++++ | ++ | + |
| 2,500 | +++ | + | − |
| 1,250 | ++ | − | − |

First Silica Gel Column Chromatography

A column was packed with silica gel (70-230 meshes) in hexane. The hexane extract was applied to the column, and the column was eluted sequentially with hexane (10), hexane:methylene chloride (7.5:2.5), hexane:methylene chloride (5:5), hexane:methylene chloride (2.5:7.5), methylene chloride (10), methylene chloride:ethyl acetate (8:2), methylene chloride:ethyl acetate (6:4), methylene chloride:ethyl acetate (4:6), methylene chloride:ethyl acetate (2:8), ethyl acetate (10), ethyl acetate:methyl alcohol (9:1), ethyl acetate:methyl alcohol (8:2), ethyl acetate:methyl alcohol (7:3), ethyl acetate:methyl alcohol (5:5), and methyl alcohol (10). These extraction solvents were passed through the column in a volume of 100 ml for the extraction solvents from hexane to methylene chloride and a volume of 300 ml for the extraction solvents from methylene chloride:ethyl acetate (8:2) to methyl alcohol, at a flow rate of 3 ml/min (see Table 11).

TABLE 11

| Extraction solvent | Volume (ml) |
|---|---|
| Hexane (10) | 100 |
| Hexane:methylene chloride (7.5:2.5) | 100 |
| Hexane:methylene chloride (5:5) | 100 |
| Hexane:methylene chloride (2.5:7.5) | 100 |
| Methylene chloride (10) | 100 |
| Methylene chloride:ethyl acetate (8:2) | 300 |
| Methylene chloride:ethyl acetate (6:4) | 300 |
| Methylene chloride:ethyl acetate (4:6) | 300 |
| Methylene chloride:ethyl acetate (2:8) | 300 |
| Ethyl acetate (10) | 300 |
| Ethyl acetate:methyl alcohol (9:1) | 300 |
| Ethyl acetate:methyl alcohol (8:2) | 300 |
| Ethyl acetate:methyl alcohol (7:3) | 300 |
| Ethyl acetate:methyl alcohol (6:4) | 300 |
| Ethyl acetate:methyl alcohol (5:5) | 300 |
| Methyl alcohol (10) | 300 |

The eluates were subjected to TLC in a mixed solvent of hexane:methylene chloride:ethyl acetate (3:1:1) so as to obtain six fractions. The six fractions (I-VI) were tested for physiological activity, and the results are shown in Table 12 below.

TABLE 12

| Concentration | Activity | | | | | |
|---|---|---|---|---|---|---|
| (μg/ml) | I | II | III | IV | V | VI |
| 4,000 | ++ | +++ | +++ | ++++ | ++++ | +++ |
| 2,000 | ++ | ++ | +++ | ++++ | +++ | ++ |
| 1,500 | ++ | + | ++ | ++++ | +++ | ++ |
| 1,000 | + | + | ++ | +++ | +++ | ++ |
| 750 | − | + | ++ | +++ | ++ | ++ |
| 250 | − | + | + | ++ | + | + |

The fraction IV within the range of methylene chloride:ethyl acetate (8:2), which shows the most excellent activity among the fractions (I-VI), was used as a sample for the isolation and purification of antifouling compounds by the second silica gel column chromatography.

Second Silica Gel Column Chromatography

A column was packed with silica gel (70-230 meshes) in hexane. The fraction IV as a sample was applied to the column, and the column was eluted sequentially with hexane (10), hexane:methylene chloride (9:1), hexane:methylene chloride (8:2), hexane:methylene chloride (7:3), hexane:methylene chloride (6:4), hexane:methylene chloride (5:5), hexane:methylene chloride (4:6), hexane:methylene chloride (3:7), hexane:methylene chloride (2:8), hexane:methylene chloride (1:9), methylene chloride (10), methylene chloride:ethyl acetate (9:1), methylene chloride:ethyl acetate (8:2), methylene chloride:ethyl acetate (7:3), methylene chloride:ethyl acetate (6:4), methylene chloride:ethyl acetate (5:5), methylene chloride:ethyl acetate (4:6), methylene chloride:ethyl acetate (3:7), methylene chloride:ethyl acetate (2:8), methylene chloride:ethyl acetate (1:9), ethyl acetate (10), ethyl acetate:methyl alcohol(9:1), ethyl acetate:methyl alcohol (8:2), ethyl acetate:methyl alcohol (7:3), ethyl acetate:methyl alcohol (6:4), ethyl acetate:methyl alcohol (5:5), and methyl alcohol (10). Each of the extraction solvents was passed through the column in a volume of 100 ml at a flow rate of 3 ml/min (see Table 13). Then, each of the elutes were subjected to TLC in a mixed solution of hexane:methylene chloride:ethyl acetate (3:1:1) so as to make six fractions (IV-i to IV-vi). The fractions were tested for inhibitory activity against the mobility of spores, and the results are shown in Table 14 below.

TABLE 13

| Extraction solvent | Volume (ml) |
|---|---|
| Hexane (10) | 100 |
| Hexane:methylene chloride (9:1) | 100 |
| Hexane:methylene chloride (8:2) | 100 |
| Hexane:methylene chloride (7:3) | 100 |
| Hexane:methylene chloride (6:4) | 100 |
| Hexane:methylene chloride (5:5) | 100 |
| Hexane:methylene chloride (4:6) | 100 |
| Hexane:methylene chloride (3:7) | 100 |
| Hexane:methylene chloride (2:8) | 100 |
| Hexane:methylene chloride (1:9) | 100 |
| Methylene chloride (10) | 100 |
| Methylene chloride:ethyl acetate (9:1) | 100 |
| Methylene chloride:ethyl acetate (8:2) | 100 |
| Methylene chloride:ethyl acetate (7:3) | 100 |
| Methylene chloride:ethyl acetate (6:4) | 100 |
| Methylene chloride:ethyl acetate (5:5) | 100 |
| Methylene chloride:ethyl acetate (4:6) | 100 |
| Methylene chloride:ethyl acetate (3:7) | 100 |
| Methylene chloride:ethyl acetate (2:8) | 100 |
| Methylene chloride:ethyl acetate (1:9) | 100 |
| Ethyl acetate (10) | 100 |
| Ethyl acetate:methyl alcohol (9:1) | 100 |
| Ethyl acetate:methyl alcohol (8:2) | 100 |
| Ethyl acetate:methyl alcohol (7:3) | 100 |
| Ethyl acetate:methyl alcohol (6:4) | 100 |
| Ethyl acetate:methyl alcohol (5:5) | 100 |
| Methyl alcohol (10) | 100 |

TABLE 14

| Concentration | Activity | | | | | |
|---|---|---|---|---|---|---|
| (μg/ml) | IV-i | IV-ii | IV-iii | IV-iv | IV-v | IV-vi |
| 4,000 | ++ | ++++ | ++++ | ++++ | ++++ | ++ |
| 2,000 | ++ | +++ | ++++ | ++++ | ++++ | ++ |
| 1,500 | ++ | ++ | ++++ | ++++ | +++ | ++ |
| 1,000 | + | ++ | ++++ | +++ | +++ | + |
| 750 | + | ++ | ++++ | +++ | +++ | + |
| 500 | + | ++ | ++++ | +++ | +++ | − |
| 375 | + | + | +++ | ++ | ++ | − |
| 250 | − | + | +++ | + | + | − |

As result, the fraction IV-iii showed the most excellent activity, and thus, was used as a sample for the isolation and purification of antifouling components by Prep-TLC.

The fraction V-iii, which shows the most excellent activity in the physiological test of the fractions obtained by performing the concentration gradient of the organic solvents in the second silica gel column chromatography, was developed on Prep-TLC to collect three fractions, i.e., IV-iii-a, IV-iii-b and IV-iii-c.

Each of the three fractions was tested for an inhibitory effect against the mobility of Enteromorpha spores, and the results are shown in Table 15 below.

TABLE 15

| | Activity | | |
|---|---|---|---|
| Concentration ((g/ml) | IV-iii-a | IV-iii-b | IV-iii-c |
| 4,000 | ++++ | ++++ | ++++ |
| 2,000 | +++ | +++ | +++ |
| 1,500 | +++ | +++ | +++ |
| 1,000 | ++ | +++ | ++ |
| 750 | ++ | +++ | ++ |
| 500 | ++ | ++ | ++ |

As a result, the fraction IV-iii-b maintained activity despite an increase in dilution rate, and thus, was used as a sample for the isolation and purification of antifouling components by Prep-HPLC.

Prep-HPLC

The active fraction IV-iii-b collected in Prep-TLC was applied to Prep-HPLC reversed column (microsorb, 21.4×250 mm), and the mobile phase was eluted with a mixed solvent of 60% acetonitrile and 40% water in the isocratic condition at a flow rate of 20 ml/min for 120 minutes. The absorbance at 213 nm was measured while collecting six fractions (K1-K5) showing the peak absorbance.

Each of the fractions collected in Prep-HPLC of the active fraction IV-iii-b collected in Prep-TLC was tested for inhibitory activity against the mobility of Enteromorpha spores, and the results are shown in Table 16 below.

TABLE 16

| Concentration | Activity | | | | | |
|---|---|---|---|---|---|---|
| ((g/ml) | K1 | K2 | K3 | K4 | K5 | K6 |
| 4,000 | | +++ | ++++ | ++++ | ++++ | ++++ |
| 2,000 | ++ | +++ | ++++ | ++++ | ++++ | ++++ |
| 1,500 | ++ | ++ | ++++ | ++++ | ++++ | +++ |
| 1,000 | + | ++ | ++++ | ++++ | ++++ | +++ |
| 500 | + | ++ | +++ | +++ | ++++ | ++ |
| 250 | − | + | ++ | +++ | +++ | + |
| 125 | − | + | ++ | ++ | +++ | + |
| 62.5 | − | − | + | + | ++ | + |

As a result, the fraction KS had the most excellent inhibitory effect on the mobility of Enteromorpha spores among the six fractions (K1-K6). Thus, the fraction K5 was used as a sample in structural analysis by GC-MS, LC-MS and NMR.

### EXAMPLE 4

### Solvent Fractionation of D. batatas Extract

The D. batatas extract obtained in Example 1 was fractionated into five fractions (A-E) by silica gel column chromatography in the following manner.

A glass tube column (10 cm×90 cm, PYREX) was packed with silica gel (70-230 meshes) in hexane. In this regard, the column was selected and used depending on the amount of the sample, and the amount of the silica gel was 50-60 times the amount of the sample. The D. batatas extract as a sample was applied to the column, and the column was developed sequentially with the following developing solvents at a flow rate of 5 ml/min: hexane, hexane:ethyl acetate=95:5, hexane:ethyl acetate=90:10, hexane:ethyl acetate=85:15, hexane:ethyl acetate:=80:20, hexane:ethyl acetate=70:30, hexane:ethyl acetate=60:40, hexane:ethyl acetate: =50:50, ethyl acetate, ethyl acetate:methanol=95:5, ethyl acetate:methanol=90:10, and ethyl acetate:methanol=80:20. The elutes were fractionated into six fractions (I-VI) by performing thin layer chromatography under the same developing solvent condition as in Example 2.

The six fractions (I-VI) were tested for inhibitory activity against the mobility of spores, and the fractions I and II, which show good activity in the test, were combined together and subjected to the second silica gel column chromatography. In this regard, the combined fraction was applied to a column, and the column was developed sequentially with the following developing at a flow rate of 3 ml/min: hexane, hexane:ethyl acetate=95:5, hexane:ethyl acetate=90:10, hexane:ethyl acetate=85:15, hexane:ethyl acetate=80:20, hexane:ethyl acetate=70:30, hexane:ethyl acetate=60:40, hexane:ethyl acetate=50:50, ethyl acetate, ethyl acetate:methanol=95:5, ethyl acetate:methanol=90:10, and ethyl acetate:methanol=80:20. The eluates were fractionated into five fractions by performing thin layer chromatography in the same developing solvent condition as in Example 2.

The effects of the land plant and algae extracts on the prevention of settlement of fouling organisms were tested on Ulva pertusa, one of typical soft algae. Ulva pertusa was collected in Kyongpodae, Kangnung-city, Kangwon-Do, Korea. The collected seaweed was transported to a laboratory and only Ulva pertusa was screened. In order to remove fouling organisms, the screened seaweed was treated three times with supersonic waves for 1 minute for each time, and then washed clean with sterilized seawater. The washed layer was simply sterilized by immersion in a mixed solution of 1% betadine and 2% trition X-100 for 1 minutes for 1 minute, followed by semi-drying.

The semi-dried Ulva pertusa was added to sterilized seawater and placed in a 20° C. incubator to induce the release of spores. 10 (l of dimethyl sulfoxide (DMSO) was placed in a prepared tube to which the seawater having spores released therein was then added. Inhibitory effects against the mobility of spores at varying concentrations of 500, 1000, 1500, 2000, 4000 (g/ml were observed with a microscope (Olympus CK-2) at 100× magnification, and the results are shown in Table 17 below. In Table 17, “++++” designates 100% inhibition of the mobility of spores, “+++” designates 95%-75% inhibition of the mobility of spores, “++” designates 75%-50% inhibition, “+” designates 50%-20% inhibition of the mobility of spores, and “−” designates no inhibition of the mobility of spores. Before inoculation with each fraction at each dilution concentration, the movement of spores in the seawater was examined for use as a control.

The five fractions (A-E) were tested for inhibitory activity against the mobility of spores, and the results are shown in Table 17 below.

TABLE 17

| Concentration | | | | | |
|---|---|---|---|---|---|
| ((g/ml) | A | B | C | D | E |
| 4,000 | ++++ | ++++ | ++++ | ++++ | ++++ |
| 2,000 | ++++ | ++++ | ++++ | ++++ | ++++ |
| 1,000 | ++++ | ++++ | ++++ | ++++ | ++++ |
| 500 | ++++ | ++++ | ++++ | ++++ | ++++ |
| 250 | ++++ | +++ | +++ | +++ | +++ |
| 125 | ++++ | +++ | +++ | +++ | +++ |

As can be seen in Table 17, the fraction A exhibited the most excellent inhibitory effect against the mobility of spores.

Second Fractionation

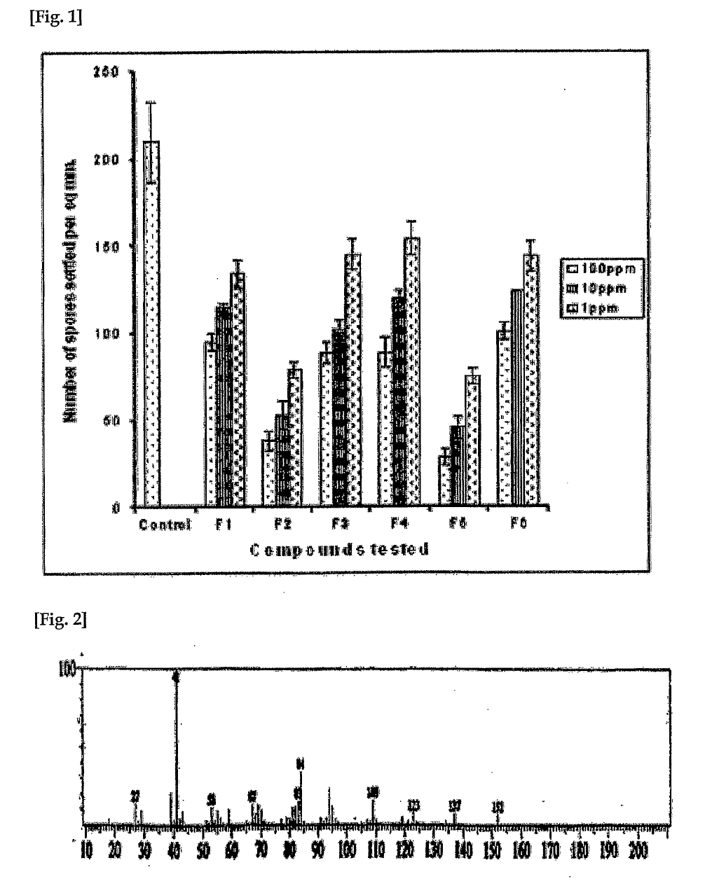

The fraction A was applied to a Prep-HPLC C18 reversed column (Microsorb, 21.4 mm×250 mm), and eluted with a mixed solvent of 80% methanol and 20% water in the isocratic condition for 60 minute at a flow rate of 5 ml/min. The absorbance at 254 nm was measured while collecting six fractions (F1-F6). Each of the fractions (F1-F6) was tested for an inhibitory effect against the mobility of Ulva pertusa, and as a result, the fractions F2 and F5 showed the most powerful activity (see Table 18). Also, the inhibitory effects of the fractions against the mobility of spores are shown in FIG. 1. As shown in FIG. 1, the fractions F2 and F5 showed a attachment inhibition of 75% at concentrations of 10 ppm and 100 ppm, and a attachment inhibition of 50% at a concentration of 1 ppm. The fractions F1, F3, F4 and F6 did not show an inhibitory effect against the attachment of spores.

TABLE 18

| Concentration | Activity | | | | | |
|---|---|---|---|---|---|---|
| (μg/ml) | F1 | F2 | F3 | F4 | F5 | F6 |
| 4,000 | ++++ | ++++ | ++++ | ++++ | ++++ | ++++ |
| 2,000 | ++++ | ++++ | ++++ | ++++ | ++++ | ++++ |
| 1,000 | +++ | ++++ | +++ | ++++ | ++++ | ++++ |
| 500 | +++ | ++++ | +++ | ++++ | ++++ | ++++ |
| 250 | +++ | ++++ | +++ | +++ | ++++ | +++ |
| 125 | + | ++++ | ++ | +++ | ++++ | ++ |

### EXAMPLE 5

### Solvent fractionation of mustard leaf extract

A column was packed with silica gel (70-230 meshes) in hexane. In this regard, the column was selected and used depending on the amount of the sample, and the amount of the silica gel was 50-60 times the amount of the sample. The mustard leaf extract as a sample was applied to the column, and the column was developed sequentially with the following developing solvents at a flow rate of 5 ml/min (see Table 19): hexane, hexane:ethyl acetate 95:5, hexane:ethyl acetate=90:10, hexane:ethyl acetate 85:15, hexane:ethyl acetate:=80:20, hexane:ethyl acetate=70:30, hexane:ethyl acetate=60:40, hexane:ethyl acetate: =50:50, ethyl acetate, ethyl acetate:methanol=95:5, ethyl acetate:methanol=90:10, and ethyl acetate:methanol=80:20. The elutes were fractionated into six fractions (I-VI) by performing thin layer chromatography under the same developing solvent condition as in Example 2.

TABLE 19

| Developing solvent | Volume (ml) |
|---|---|
| Hexane | 2000 |
| Hexane:ethyl acetate (95:5) | 2000 |
| Hexane:ethyl acetate (90:10) | 2000 |
| Hexane:ethyl acetate (85:15) | 2000 |
| Hexane:ethyl acetate (80:20) | 2000 |
| Hexane:ethyl acetate (70:30) | 2000 |
| Hexane:ethyl acetate (60:40) | 2000 |
| Hexane:ethyl acetate (50:50) | 2000 |
| Ethyl acetate | 2000 |
| Ethyl acetate:methyl alcohol (95:5) | 2000 |
| Ethyl acetate:methyl alcohol (90:10) | 2000 |
| Ethyl acetate:methyl alcohol (80:20) | 2000 |

The effects of the fractions I-VI on the inhibition of attachment of fouling organisms were tested on Ulva pertusa, one of typical soft algae. Ulva pertusa was collected in Kyongpodae, Kangnung-city, Kangwon-Do, Korea. The collected seaweed was transported to a laboratory in which only Ulva pertusa was screened. In order to remove fouling organisms, the screened algae were treated three times with supersonic waves for 1 minute for each time, and then washed clean with sterilized seawater. The washed algae were simply sterilized by immersion in a mixed solution of 1% betadine and 2% trition X-100 for 1 minute, followed by semi-drying. The semi-dried Ulva pertusa was added to sterilized seawater and placed in a 80 μmol m⁻²s⁻¹, 20° C. incubator to induce the release of spores.

10 μl of dimethyl sulfoxide (DMSO) was placed in a prepared tube, to which the seawater having spores released therein was then added. The Inhibitory effects of the fractions against the mobility of spores at varying concentrations of 500, 1000, 1500, 2000, 4000 μg/ml were observed with a microscope (Olympus CK-2) at 100× magnification, and the results are shown in Table 20 below. In Table 20, “++++” designates more than 95% inhibition of the mobility of spores, “+++” designates 95%-75% inhibition of the mobility of spores, “++” designates 75%-50% inhibition, “+”, designates 50%-20% inhibition of the mobility of spores, and “−” designates no inhibition of the mobility of spores. Before inoculation with each fraction at each dilution concentration, the movement of spores in the seawater was examined and the result was used as a control.

The five fractions (A-E) were tested for inhibitory activity against the mobility of spores, and the results are shown in Table 20 below. As can be seen in Table 20, the fraction III showed strong activity.

TABLE 20

| Concentration | Mobility inhibitory activity | | | | | |
|---|---|---|---|---|---|---|
| (μg/ml) | I | II | III | IV | V | VI |
| 4,000 | ++++ | ++++ | ++++ | ++++ | ++++ | ++++ |
| 2,000 | ++++ | ++++ | ++++ | ++++ | ++++ | ++++ |
| 1,000 | +++ | ++++ | ++++ | ++++ | ++++ | ++++ |
| 500 | +++ | +++ | ++++ | ++++ | ++++ | +++ |
| 250 | +++ | +++ | ++++ | ++ | +++ | ++ |
| 125 | + | ++ | ++++ | ++ | ++ | ++ |

### EXAMPLE 6

### Solvent Fraction of Lemon Extract

A glass tube column (10 cm×90 cm; equipped with PTEE end plate) was packed with silica gel (70-230 meshes) in hexane. In this regard, the column was selected and used depending on the amount of the sample, and the amount of the silica gel was 50-60 times the amount of the sample. The lemon extract as a sample was applied to the column, and the column was developed sequentially with the following developing solvents at a flow rate of 5 ml/min (see Table 21): hexane, hexane:ethyl acetate=95:5, hexane:ethyl acetate=90:10, hexane:ethyl acetate=85:15, hexane:ethyl acetate: =80:20, hexane:ethyl acetate=70:30, hexane:ethyl acetate=60:40, hexane:ethyl acetate: =50:50, ethyl acetate, ethyl acetate:methanol=95:5, ethyl acetate:methanol=90:10, and ethyl acetate:methanol=80:20. The elutes were fractionated into six fractions (A-F) by performing thin layer chromatography under the same developing solvent condition as in Example 2.

TABLE 21

| Developing solvent | Volume (ml) |
|---|---|
| Hexane | 2000 |
| Hexane:ethyl acetate (95:5) | 2000 |
| Hexane:ethyl acetate (90:10) | 2000 |
| Hexane:ethyl acetate (85:15) | 2000 |
| Hexane:ethyl acetate (80:20) | 2000 |
| Hexane:ethyl acetate (70:30) | 2000 |
| Hexane:ethyl acetate (60:40) | 2000 |
| Hexane:ethyl acetate (50:50) | 2000 |
| Ethyl acetate | 2000 |
| Ethyl acetate:methyl alcohol (95:5) | 2000 |
| Ethyl acetate:methyl alcohol (90:10) | 2000 |
| Ethyl acetate:methyl alcohol (80:20) | 2000 |

The effects of the fractions A-F on the inhibition of attachment of fouling organisms were tested on Ulva pertusa, one of typical soft algae. Ulva pertusa was collected in Kyongpodae, Kangnung-city, Kangwon-Do, Korea. The collected seaweed was transported to a laboratory in which only Ulva pertusa was screened. In order to remove fouling organisms, the screened algae were treated three times with supersonic waves for 1 minute for each time, and then washed clean with sterilized seawater. The washed algae were simply sterilized by immersion in a mixed solution of 1% betadine and 2% trition X-100 for 1 minute, followed by semi-drying. The semi-dried Ulva pertusa was added to sterilized seawater and placed in an 80-μmol m⁻²s⁻¹ and 20° C. incubator to induce the release of spores.

10 (l of dimethyl sulfoxide (DMSO) was placed in a prepared tube, to which the seawater having spores released therein was then added. The inhibitory effects of the fractions against the mobility of spores at varying concentrations of 500, 1000, 1500, 2000, 4000 (g/ml were observed with a microscope (Olympus CK-2) at 100× magnification, and the results are shown in Table 22 below. In Table 22, “++++” designates more than 95% inhibition of the mobility of spores, “+++” designates 95%-75% inhibition of the mobility of spores, “++” designates 75%-50% inhibition, “+” designates 50%-20% inhibition of the mobility of spores, and “−” designates no inhibition of the mobility of spores. Before inoculation with each fraction at each dilution concentration, the movement of spores in the seawater was examined and the result was used as a control.

The six fractions (A-F) were tested for inhibitory activity against the mobility of spores, and the results are shown in Table 22 below. As can be seen in Table 22, the fraction B-D showed strong activity.

TABLE 22

| Concentration | Mobility inhibitory activity | | | | | |
|---|---|---|---|---|---|---|
| ((g/ml) | A | B | C | D | E | F |
| 4,000 | ++++ | ++++ | ++++ | ++++ | ++++ | ++++ |
| 2,000 | ++++ | ++++ | ++++ | ++++ | ++++ | ++++ |
| 1,000 | ++++ | ++++ | ++++ | ++++ | ++++ | ++++ |
| 500 | +++ | ++++ | ++++ | ++++ | ++++ | +++ |
| 250 | +++ | ++++ | ++++ | ++++ | +++ | +++ |
| 125 | +++ | +++ | ++++ | ++++ | ++ | ++ |

### EXAMPLE 7

### Solvent Fractionation of Blueberry Extract

A glass tube column (10 cm×90 cm; equipped with PTEE end plate) was packed with silica gel (70-230 meshes) in hexane, in which the column was selected and used depending on the amount of the sample, and the amount of the silica gel was 50-60 times the amount of the sample. The blueberry extract as a sample was applied to the column, and the column was developed sequentially with the following developing solvents at a flow rate of 5 ml/min (see Table 23): hexane, hexane:ethyl acetate=95:5, hexane:ethyl acetate=90:10, hexane:ethyl acetate=85:15, hexane:ethyl acetate:=80:20, hexane:ethyl acetate=70:30, hexane:ethyl acetate=60:40, hexane:ethyl acetate: =50:50, ethyl acetate, ethyl acetate:methanol=95:5, ethyl acetate:methanol=90:10, and ethyl acetate:methanol=80:20. The elutes were fractionated into six fractions (a-f) by performing thin layer chromatography under the same developing solvent condition as in Example 2.

TABLE 23

| Developing solvent | Volume (ml) |
|---|---|
| Hexane | 2000 |
| Hexane:ethyl acetate (95:5) | 2000 |
| Hexane:ethyl acetate (90:10) | 2000 |
| Hexane:ethyl acetate (85:15) | 2000 |
| Hexane:ethyl acetate (80:20) | 2000 |
| Hexane:ethyl acetate (70:30) | 2000 |
| Hexane:ethyl acetate (60:40) | 2000 |
| Hexane:ethyl acetate (50:50) | 2000 |
| Ethyl acetate | 2000 |
| Ethyl acetate:methyl alcohol (95:5) | 2000 |
| Ethyl acetate:methyl alcohol (90:10) | 2000 |
| Ethyl acetate:methyl alcohol (80:20) | 2000 |

The effects of the fractions a-f on the prevention of settlement of fouling organisms were tested on Ulva pertusa, one of typical soft algae. Ulva pertusa was collected in Kyongpodae, Kangnung-city, Kangwon-Do, Korea. The collected seaweed was transported to a laboratory in which only Ulva pertusa was screened. In order to remove fouling organisms, the screened layer was treated three times with supersonic waves for 1 minute for each time, and then washed clean with sterilized seawater. The washed layer was simply sterilized by immersion in a mixed solution of 1% betadine and 2% trition X-100 for 1 minute, followed by semi-drying. The semi-dried Ulva pertusa was added to sterilized seawater and placed in an 80-μmol m⁻²s⁻¹ and 20° C. incubator to induce the release of spores.

10 μl of dimethyl sulfoxide (DMSO) was placed in a prepared tube, to which the seawater having spores released therein was then added. The inhibitory effects of the fractions against the mobility of spores at varying concentrations of 500, 1000, 1500, 2000, 4000 μg/ml were observed with a microscope (Olympus CK-2) at 100× magnification, and the results are shown in Table 24 below. In Table 24, “++++” designates more than 95% inhibition of the mobility of spores, “+++” designates 95%-75% inhibition of the mobility of spores, “++” designates 75%-50% inhibition, “+” designates 50%-20% inhibition of the mobility of spores, and “−” designates no inhibition of the mobility of spores. Before inoculation with each fraction at each dilution concentration, the movement of spores in the seawater was examined and the result was used as a control.

The six fractions (a-f) were tested for inhibitory activity against the mobility of spores, and the results are shown in Table 24 below. As can be seen in Table 24, the fraction c and d showed strong activity.

TABLE 22

| | Mobility inhibitory activity | | | | | |
|---|---|---|---|---|---|---|
| Concentration (μg/ml) | a | b | c | d | e | f |
| 4,000 | ++++ | ++++ | ++++ | ++++ | ++++ | ++++ |
| 2,000 | ++++ | ++++ | ++++ | ++++ | ++++ | ++++ |
| 1,000 | ++++ | ++++ | ++++ | ++++ | ++++ | ++++ |
| 500 | +++ | ++++ | ++++ | ++++ | ++++ | +++ |
| 250 | +++ | +++ | ++++ | ++++ | ++ | +++ |
| 125 | +++ | +++ | ++++ | ++++ | ++ | ++ |

### EXAMPLE 8

### Identification of Plant-Derived Antifouling Substances

(1) Analysis of Citrus sp.-Derived Substance

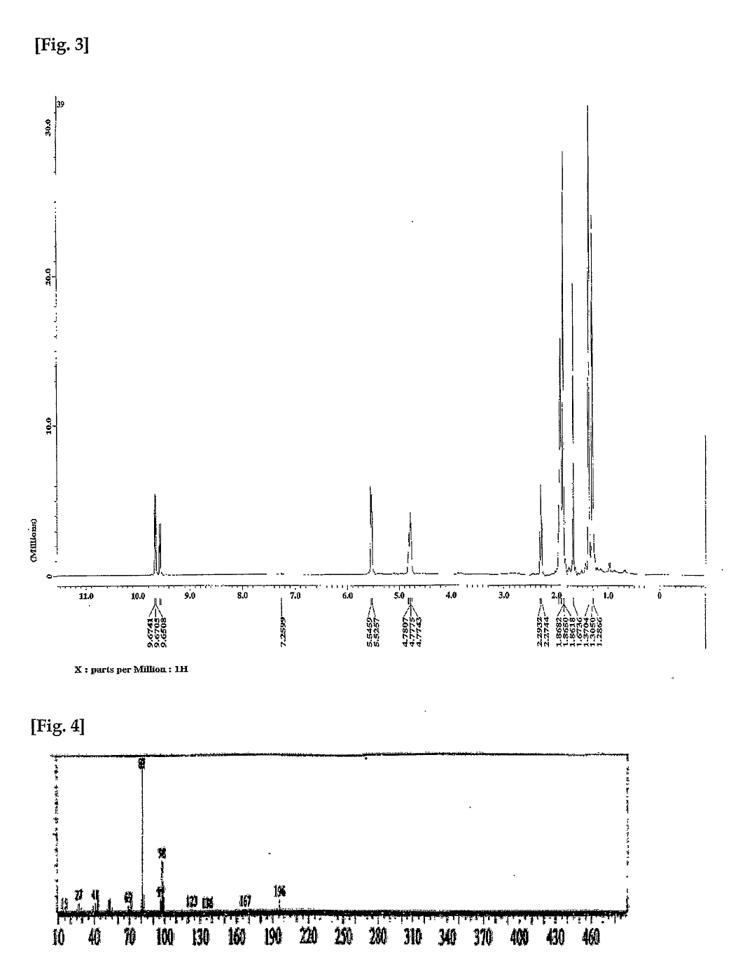

GC-MS results for the Citrus sp.-derived fraction K4 in Example 3 are shown in FIG. 2, and the NMR data for the fraction K4 are shown in FIG. 3. Also, the fraction K4 has a structure of the following formula 1:

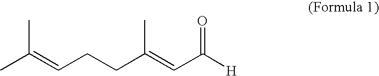

As a result, it was found that the antifouling substance with excellent antifouling activity, isolated and purified from Citrus sp., was 3,7-dimethyl-2,6-octadienal.

(2) Analysis of Brassica-Derived Substance

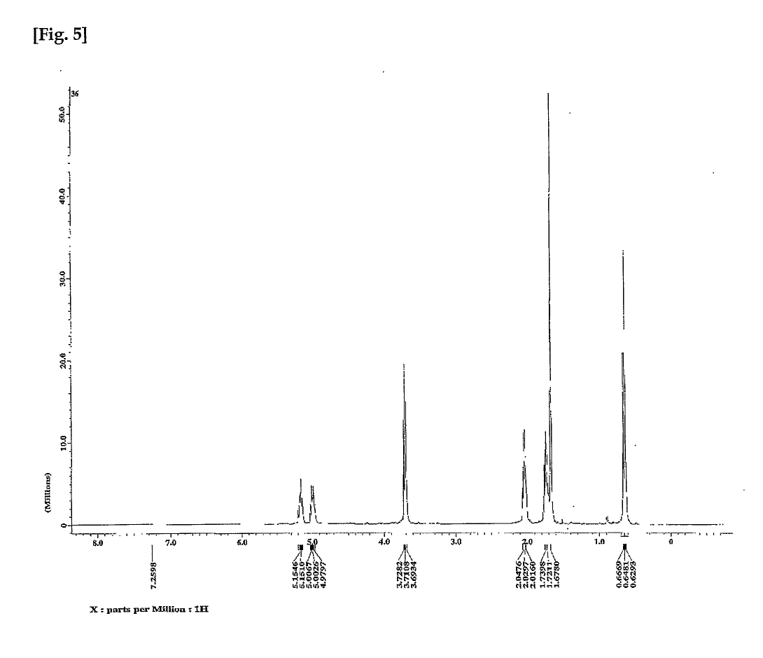

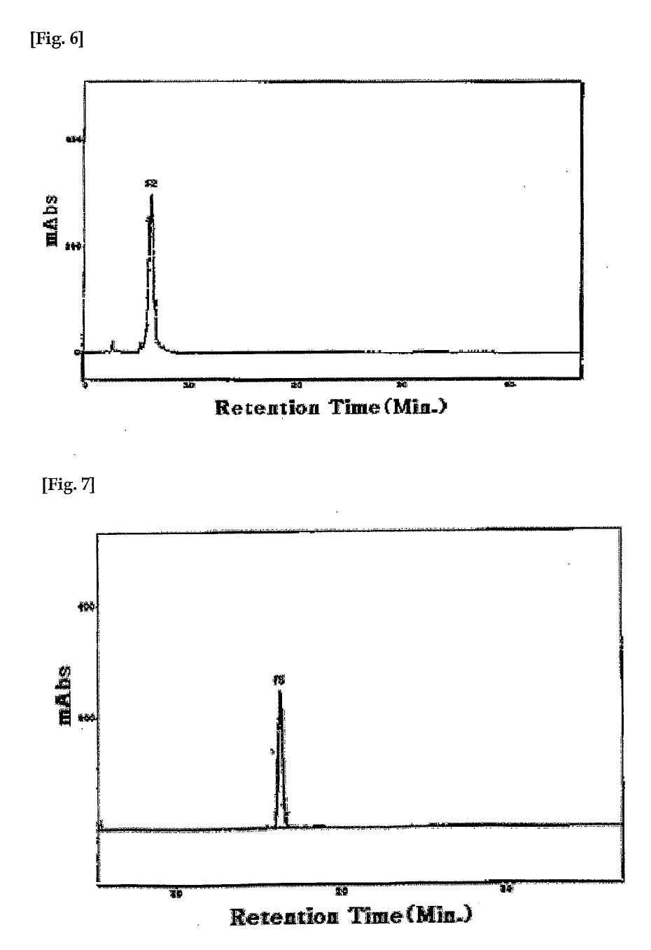

GC-MS results for the Brassica-derived fraction K5 in Example 4 are shown in FIG. 4, and the NMR data for the fraction K5 are shown in FIG. 5. Also, the fraction K5 has a structure of the following formula 2:

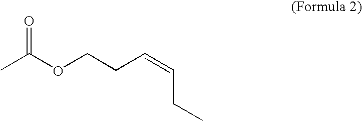

As a result, it was found that the antifouling substance with excellent antifouling activity, isolated and purified from Brassica, was cis-3-hexenyl acetate.

(3) Analysis of D. Batatas-Derived Substance HPLC/GC Mass Spectrum

Each of the fractions fractionated by Prep-HPLC was applied to a Prep-HPLC C18 reversed phase column (Microsorb, 4.6 mm×250 mm, Cosmosil) and eluted with a mixed solution of 80% methanol and 20% water for 60 minutes at a flow rate of 1.0 ml/min. The absorbance of each of the eluted fractions F2 and F5 at 254 nm was measured and the results for the fractions F2 and F5 are shown in FIGS. 6 and 7, respectively. From the HPLC, only the active portion (80% methanol concentration) was recovered, dried and dissolved in methanol, 1 mg of the solution was applied to a GC/MS column (Hewlett-Packard, 30 m×0.25 mm×0.25 μm) and analyzed by split injection (1:50) at an injection rate of 0.6 ml/min using helium as mobile phase gas.

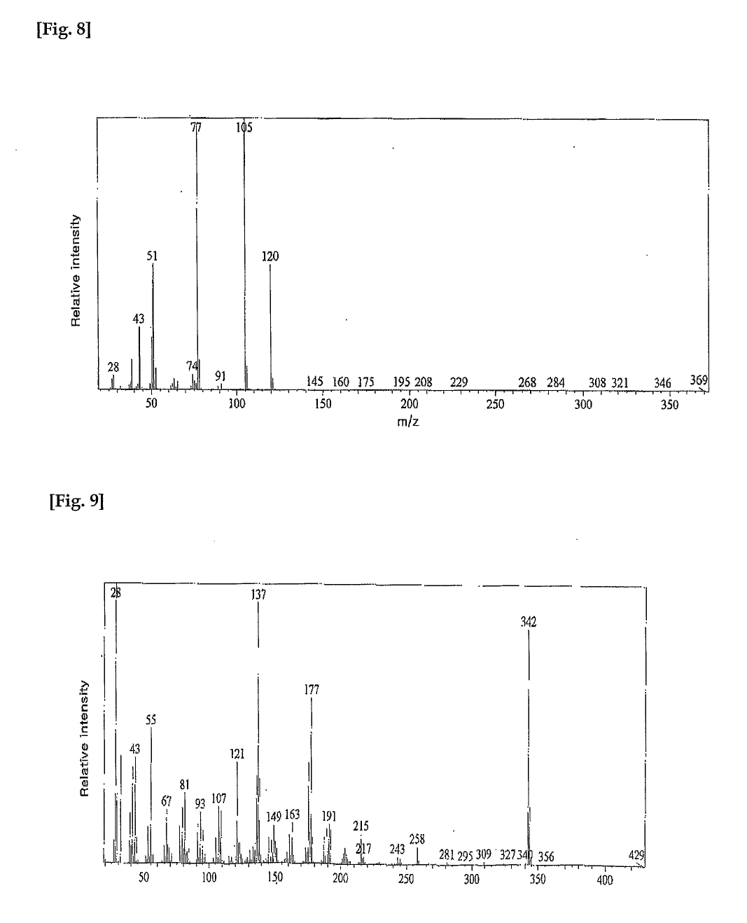

The molecular weight of each of the fractions F2 and F5 was determined by GC MS (mass spectrum), and the results of GC-MS for the fractions F2 and F5 are shown in FIGS. 8 and 9, respectively. Rt: 2.8-7.163 min, 71.56 min; Molecular ion: M+ −369, −342.

Nuclear Magnetic Resonance

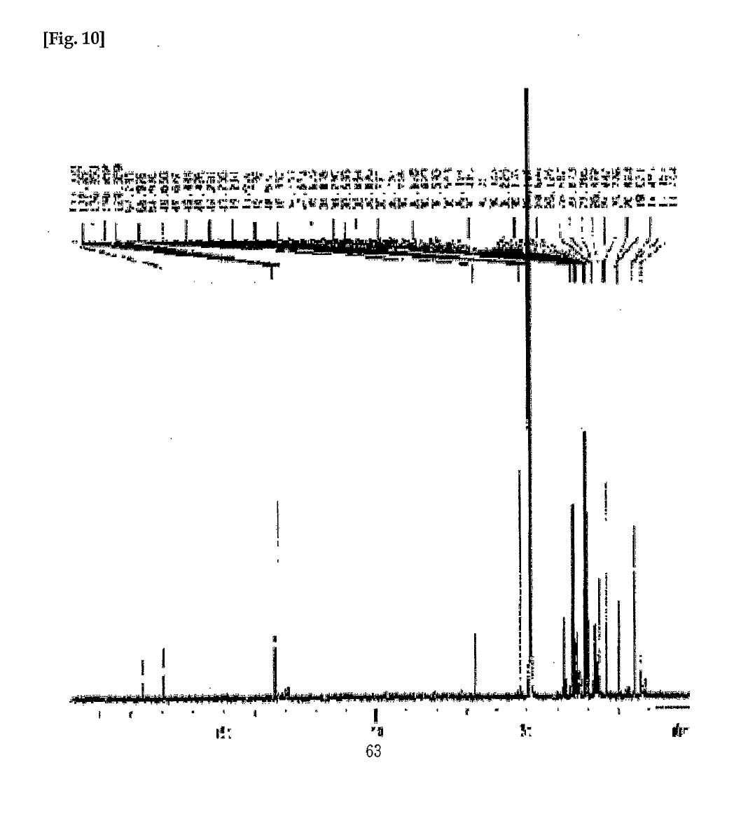

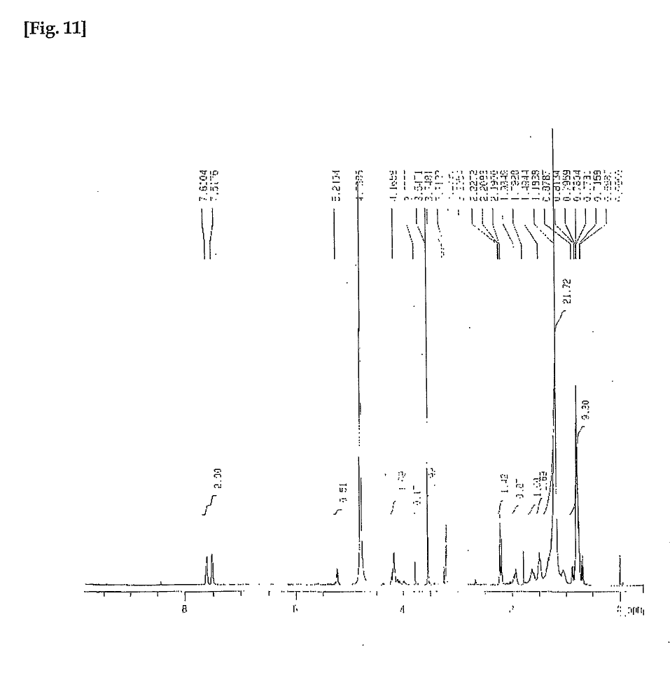

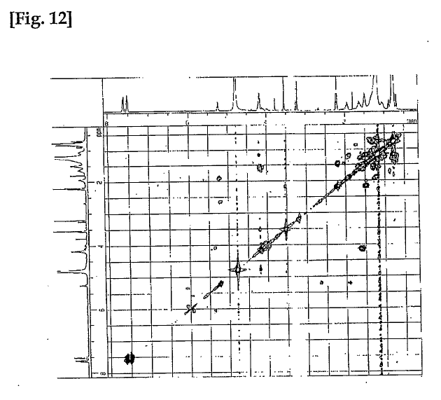

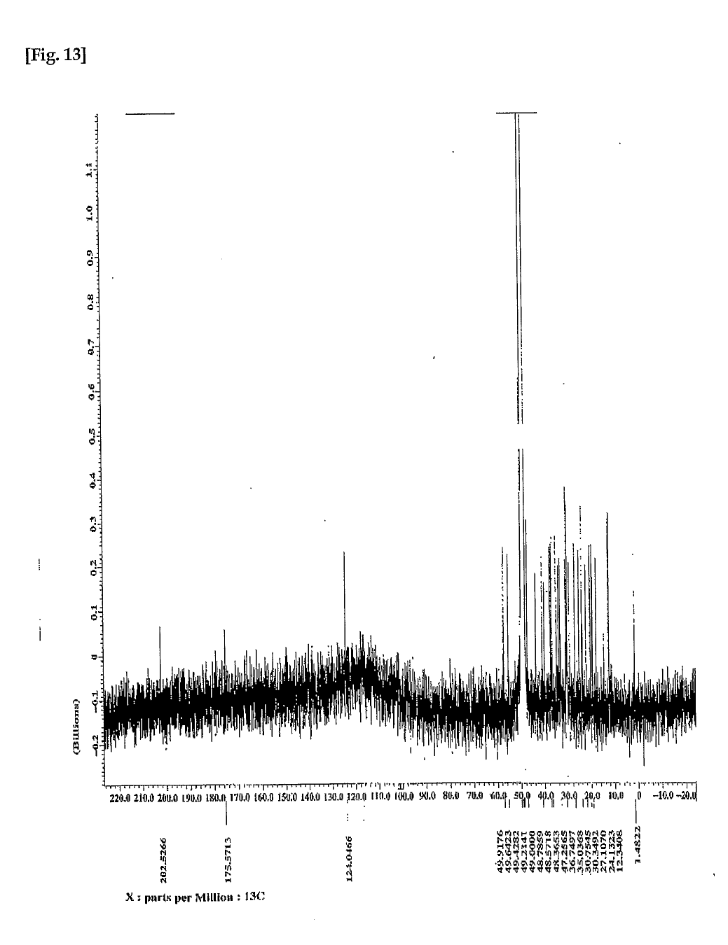

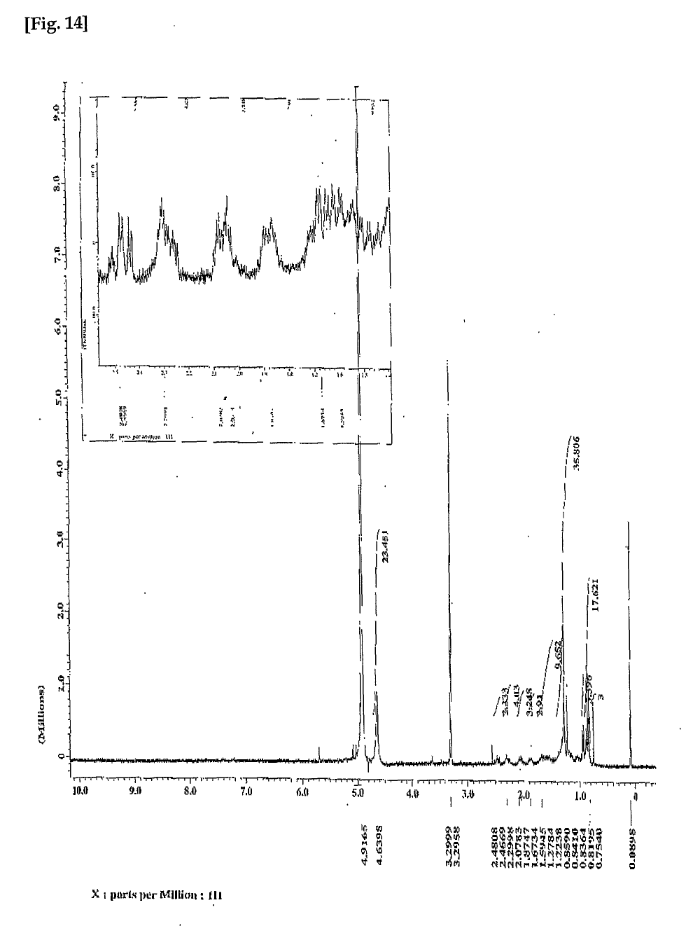

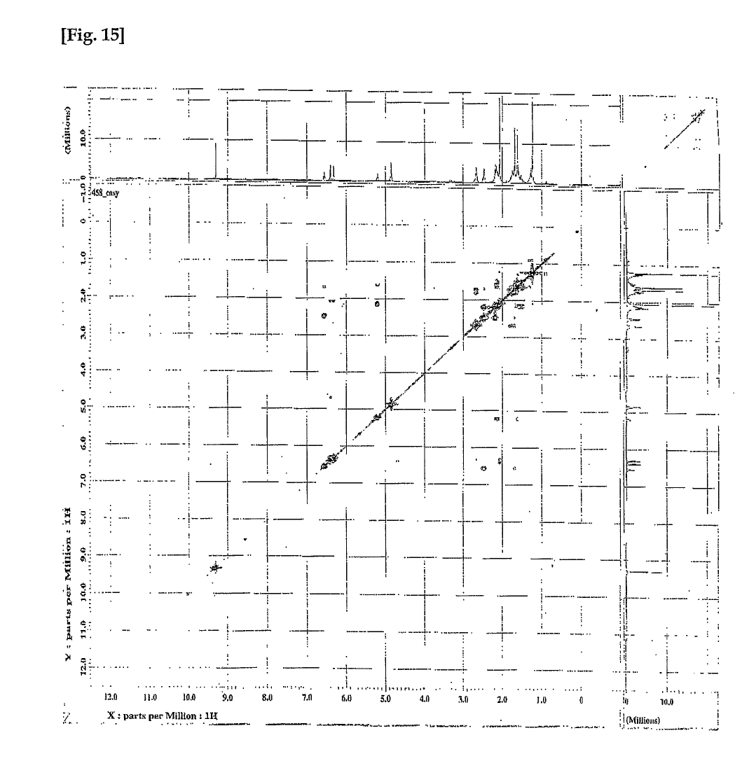

The fractions F2 and F5 fractionated by HPLC were analyzed by H nuclear magnetic resonance and C nuclear magnetic resonance, and the results are shown in FIGS. 10 to 15. As shown in FIG. 11, the ¹H NMR (500 MHz, CDCl₃/TMS) spectrum of the fraction F2 showed a carbonyl-based methyl group in a single signal at δ2.05, which was assumed to be an acetoxy methyl proton. Also, it showed four aromatic protons in a complex form at δ7.53 and δ7.72. The ¹³C NMR spectrum of the fraction F2, which is an aromatic keto compound, showed acetoxy carbon at δ171.4 and other aromatic carbons at δ18-131. From these data, the fraction F2 was found to be acetophenone (Formula 3). The ¹H NMR (500 MHz, CDCl₃/TMS) spectrum of the fraction F5 showed 6 methyl protons consisting of three pairs at δ0.95-1.03, and a methyl proton in a single signal at δ1.25. Also, it showed hydroxyl protons and hydroxyl acid in complex signals at δ3.45. From these data, it was found that the fraction F5 consisted of complex long chain alcohol and acid. The ¹³C NMR spectrum of the fraction F5 showed methyl, methylene and acetyl carbonyl groups at δ3.45. From all such results, the fraction was found to be a mixture of 1-octadecanol and arachadic acid (eicosanoic acid) (Formulas 4 and 5).

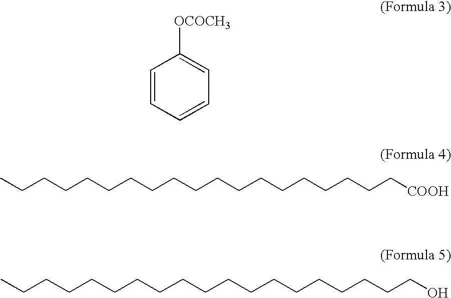

(4) Analysis of Mustard Leaf-Derived Substance

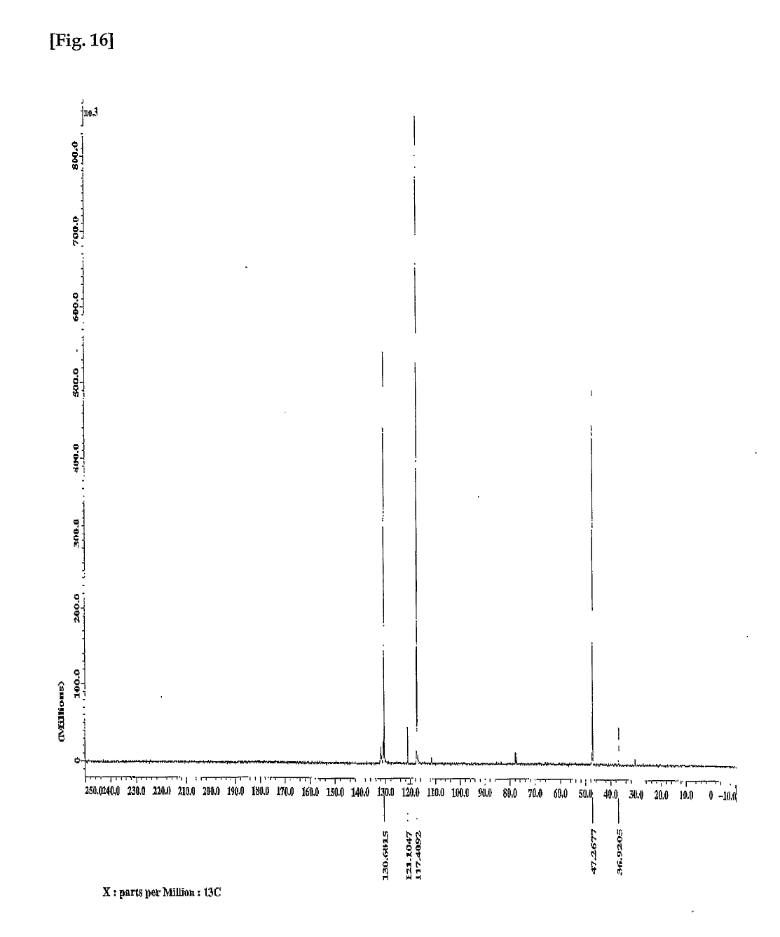

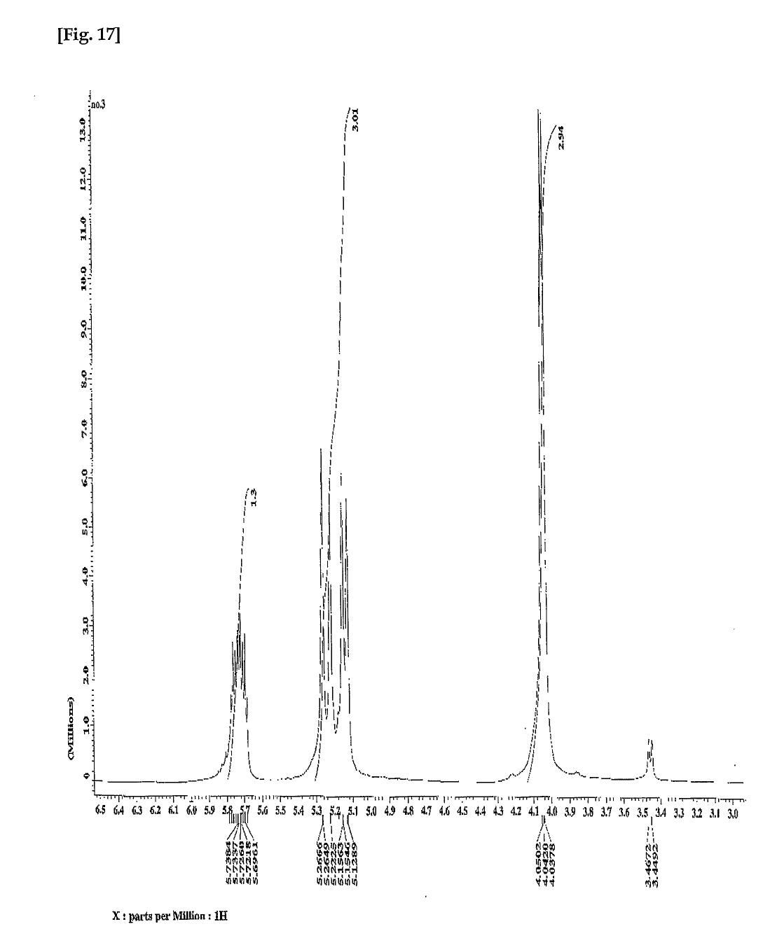

H-NMR analysis and C-NMR analysis for the mustard leaf-derived fraction III obtained in Example 5 were performed and the analysis results are shown in FIGS. 16 and 17, respectively. As a result, the fraction III was found to be allyl isothiocyanate having a structure of the following formula 6.

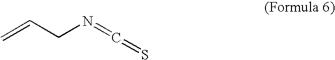

(5) Analysis of Lemon-Derived Substances

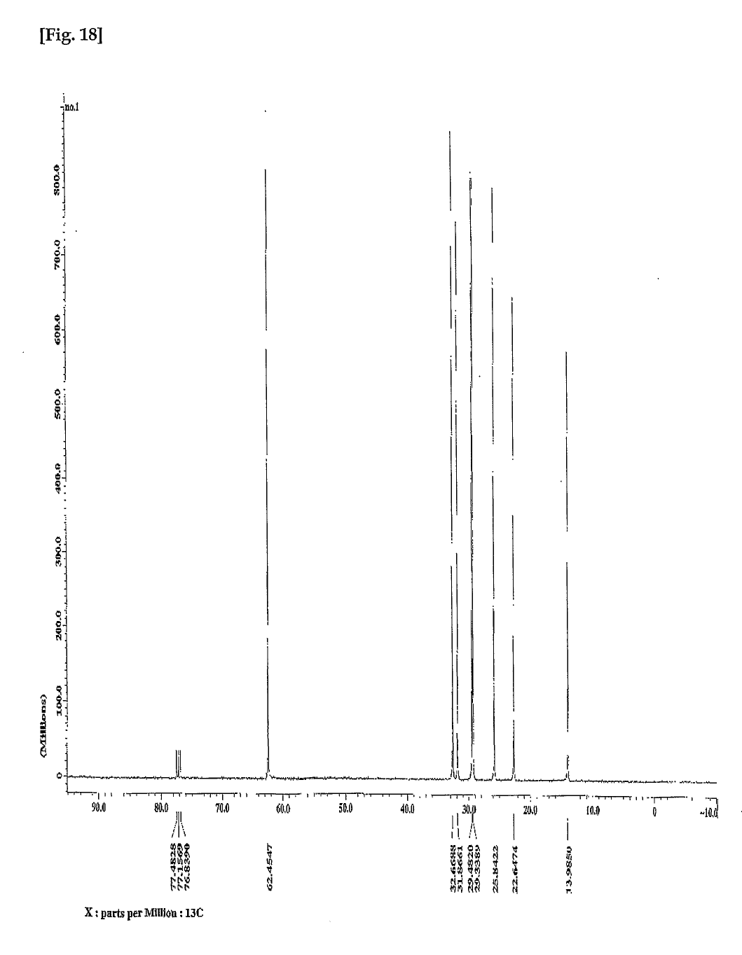

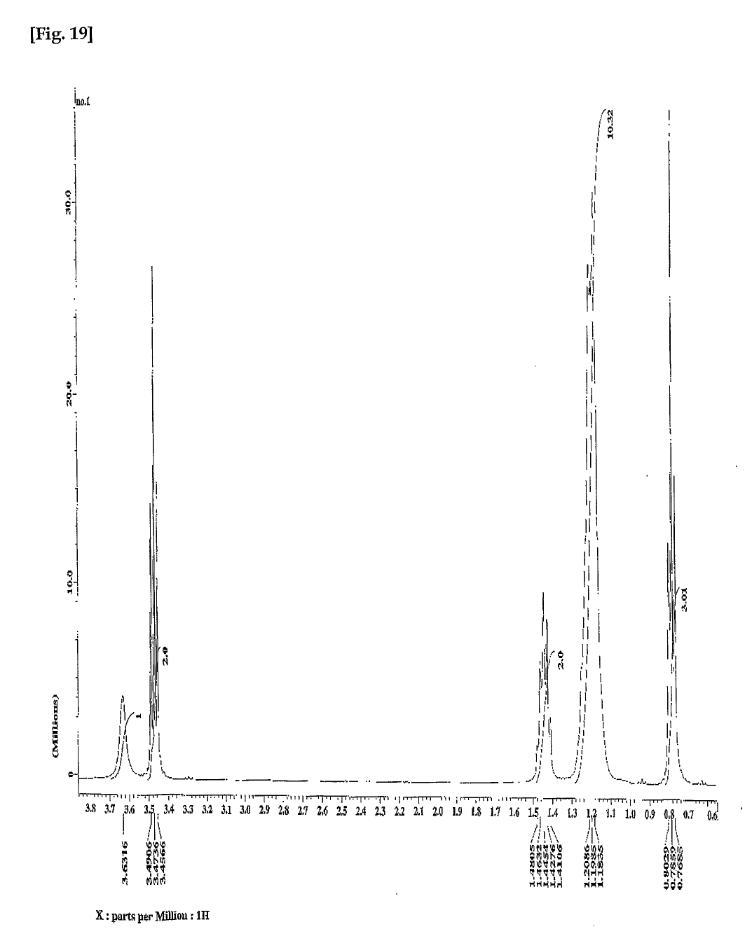

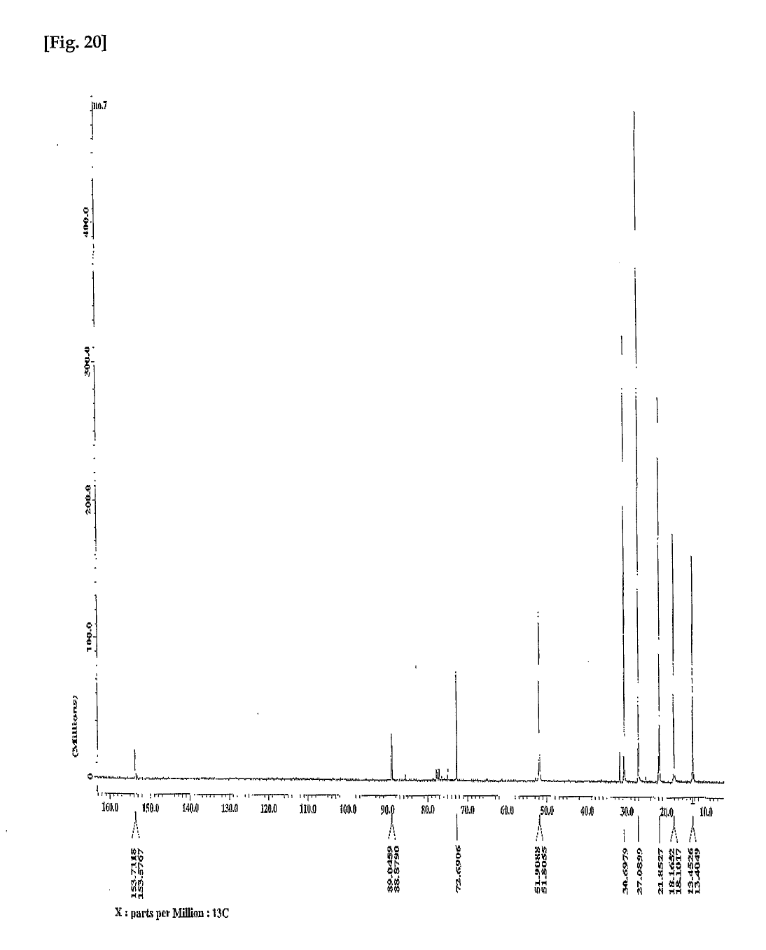

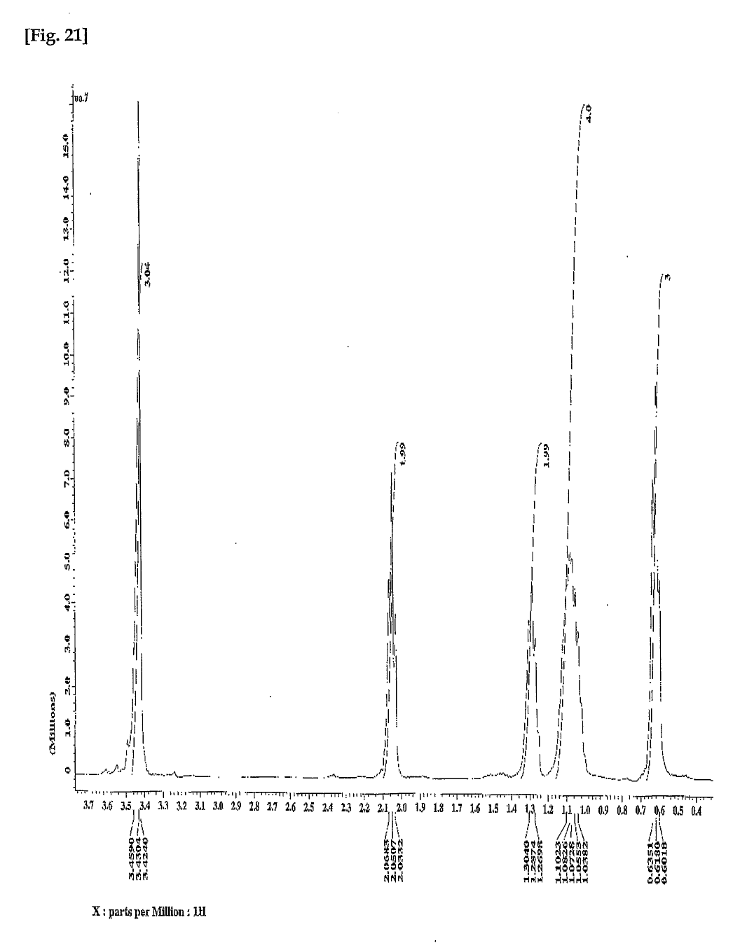

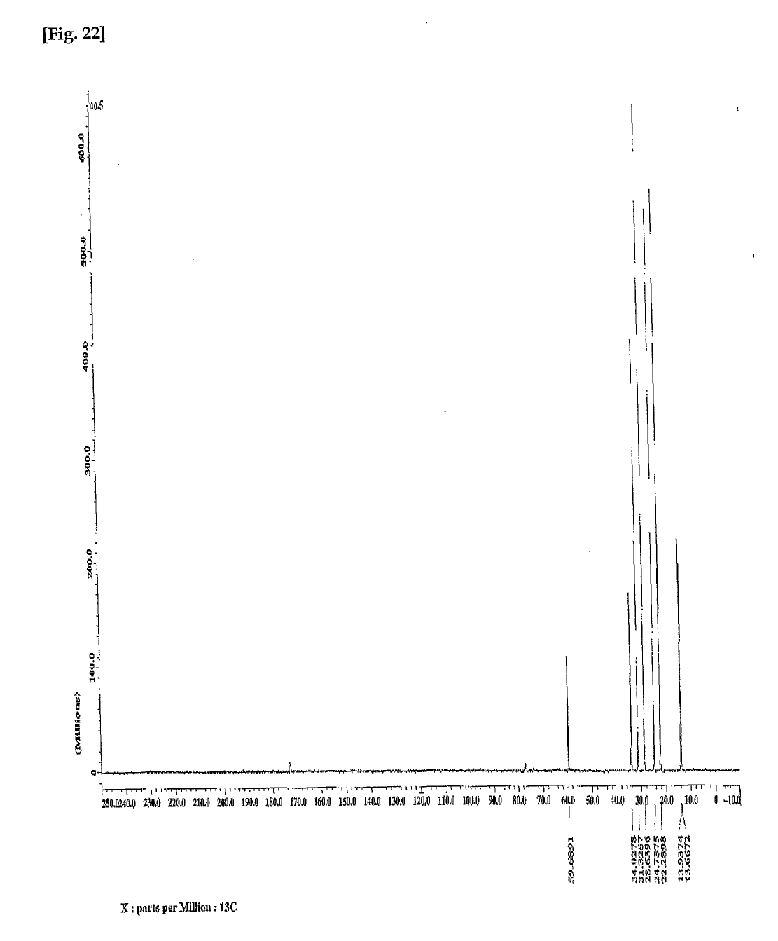

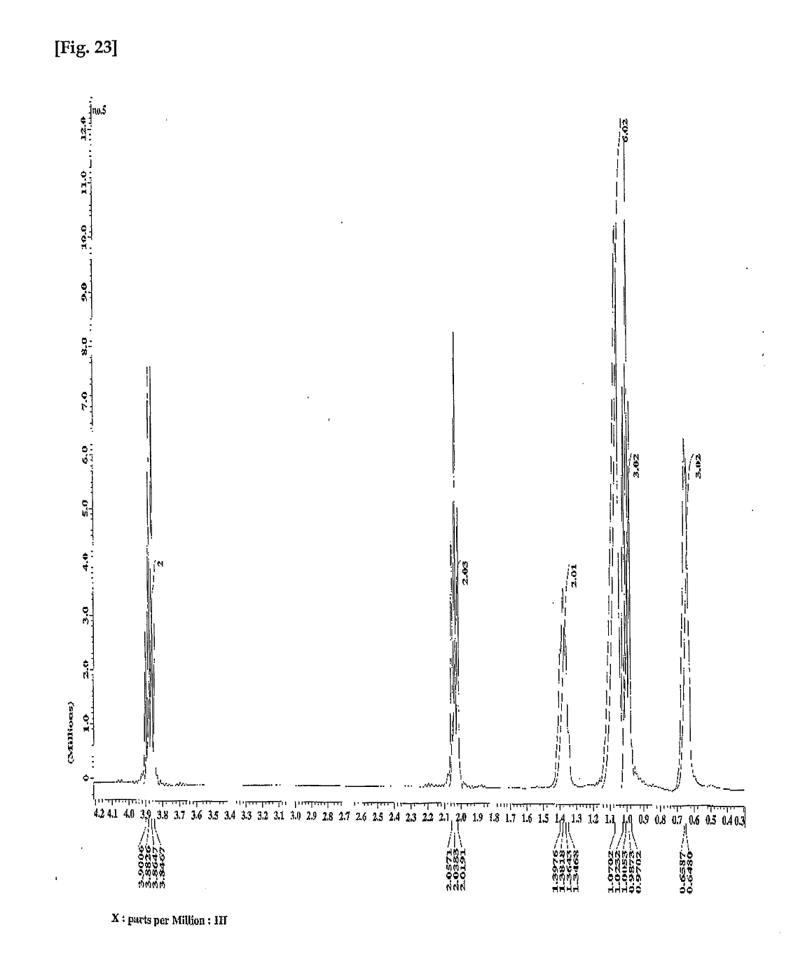

The lemon-derived fractions B, C and D obtained in Example 6 were analyzed by H-NMR, and C-NMR, and the results are shown in FIG. 18 to 23. As a result, the fractions B, C and D were found to be 1-octanol, methyl caporate and ethyl heptanoate, respectively. These compounds have structures of the following formulas 7 to 9, respectively.

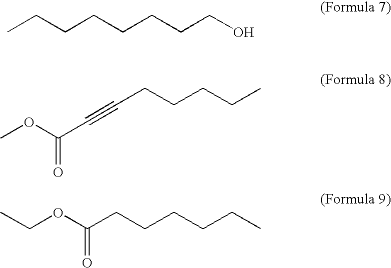

(6) Analysis of Blueberry-Derived Substances

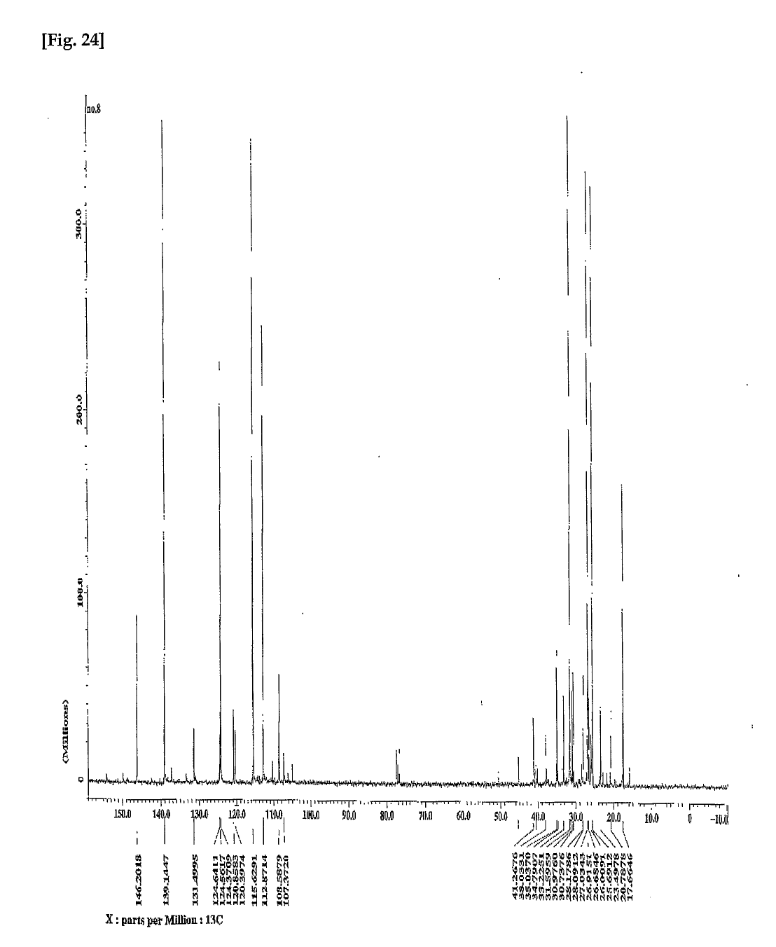

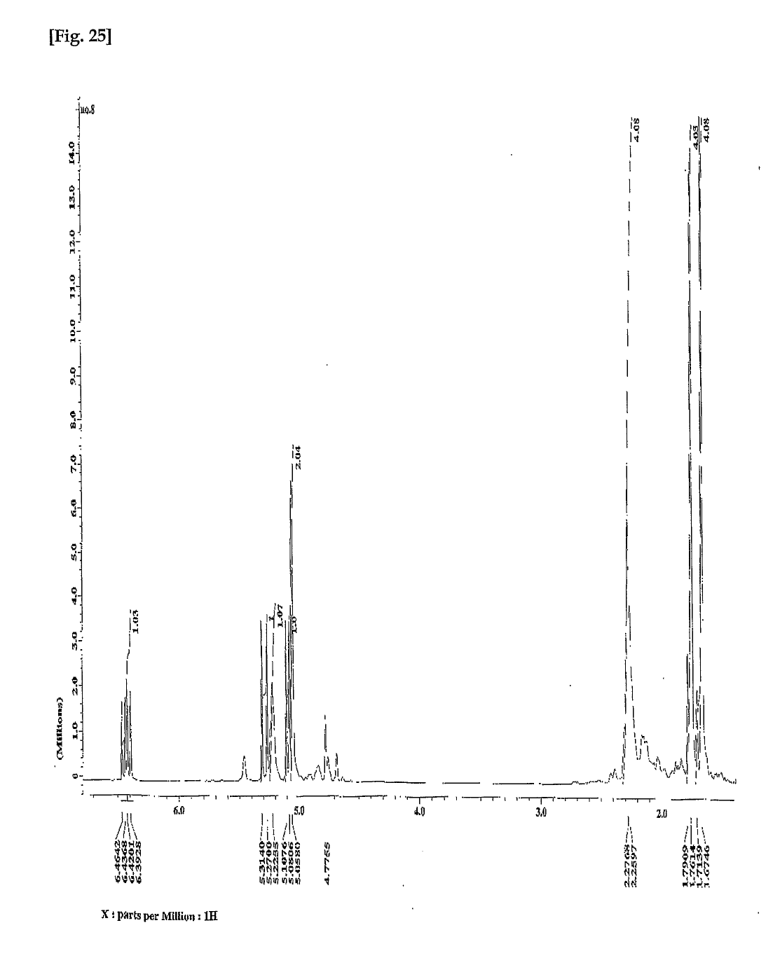

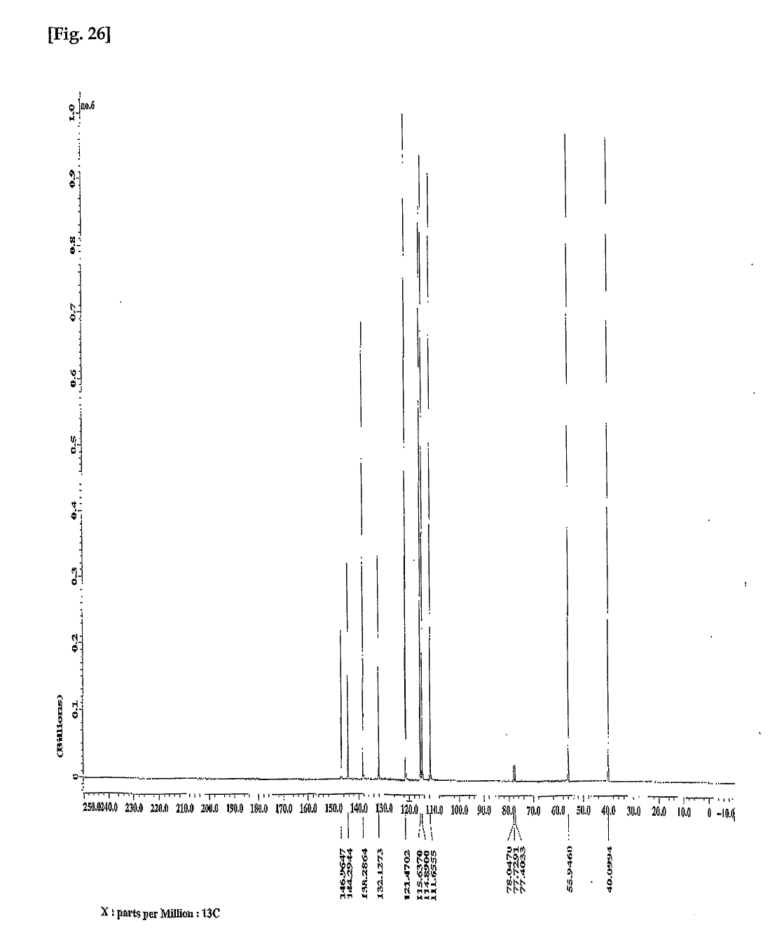

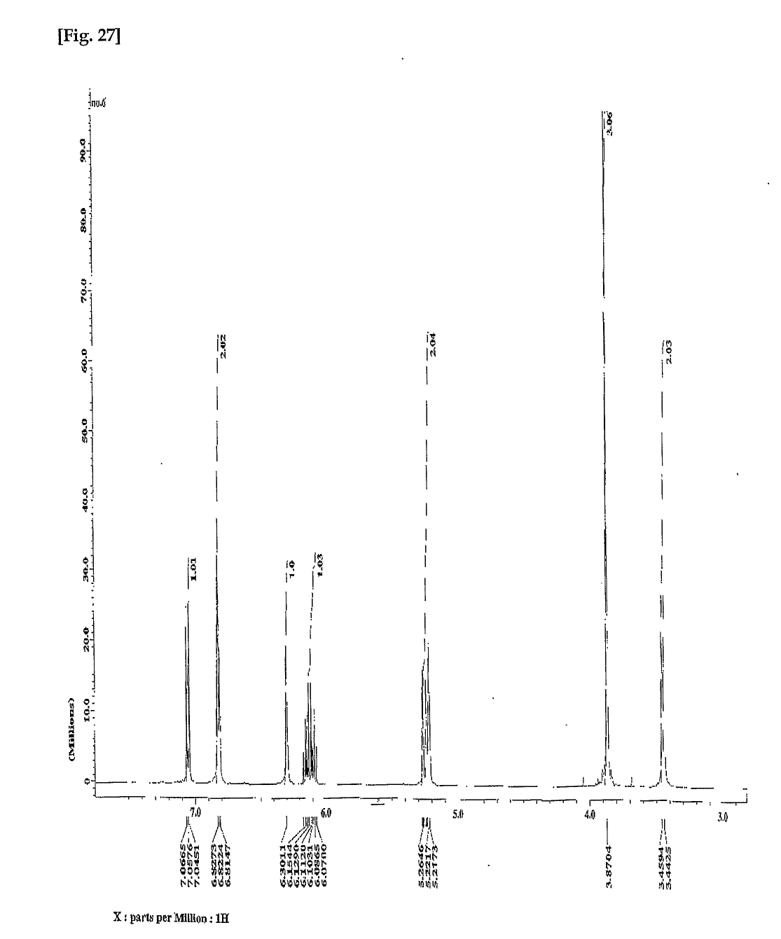

The blueberry-derived fractions c and d obtained in Example 7 were analyzed by H-NMR and C-NMR, and the results are shown in FIGS. 24 to 27, respectively. As a result, the fraction c was found to be beta-myrcene having a structure of the following formula 10, and the fraction d was found to be eugenol having a structure of the following formula 11.

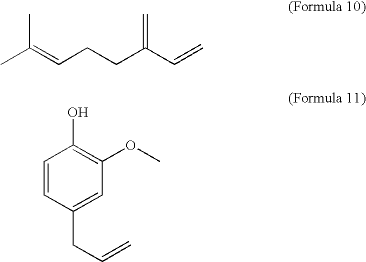

### EXAMPLE 9

### Safety Test

3,7-dimethyl-2,6-octadienal is a light yellow-colored liquid and has lemon-like flavor. The physical properties of this compound are as follows: a melting point of less than 10° C., a boiling point of 220-240° C., a specific gravity of 0.885-0.893, and poorly soluble in water. This compound was administered orally to mice and tested for toxicity, and the results were as follows: LD₅₀>4,960 mg/kg, ORAL-MUS LD₅₀>6,000 mg/kg, and IPR (Intraperitoneal)-RAT LD₅₀>460 mg/kg.

Cis-3-hexenyl acetate is a light yellow-colored liquid and has the following properties: a boiling point of 86° C., insoluble in water, and insoluble in organic solvent. This compound was administered to rabbits in oral and transdermal routes and tested for toxicity, and the results are as follows: LD₅₀>5 g/kg (transdermal), and LD₅₀>5 g/kg (oral).

Each of acetophenone, arachadic acid, methyl caporate, ethyl heptanoate, allyl isothiocyanate, beta-myrcene, eugenol, 1-octadecanol and 1-octanol was dissolved in dimethylsulfoxide (DMSO) and diluted with water. Then, 10 mg/kg of each of the dilutions was administered to each mouse group (consisting of 10 mice), and the mice were observed for 7 days. The observation result showed no death of the mice.

### EXAMPLES 10-26

### Preparation of Antifouling Paints

Resin and rosin were completely dissolved in xylene and a small amount of methyl isobutyl ketone. TO the solution, zinc oxide and iron oxide as pigments were added, and dispersed two times with a sand mill. To this mixture, an antifouling agent and thickener given in Table 25 below were added. The resulting mixture was stirred with a high-speed stirrer at 3500 rpm for 60 minutes. Then, the remaining ketone solvent was added and stirred, thus preparing antifouling paints.

TABLE 25

| | Antifouling substance | Resin (10 wt | Solvent (23 wt | Pigment (40 wt | Thickener (2 wt |
|---|---|---|---|---|---|
| | (5 wt parts) | parts) | parts) | parts) | parts) |
| Example 10 | Ethyl hepanoate | 5 wt parts of vinyl | 10 wt parts of | 25 wt parts of | Polyimide wax |
| | | resin/5 wt parts of | xylene/13 wt | zinc oxide/15 wt | |
| | | rosin | parts of methyl | parts of iron | |
| | | | isobutyl ketone | oxide | |
| Example 11 | Cis-3-hexenyl-acetoate | The same as | The same as | The same as | The same as |
| | | above | above | above | above |
| Example 12 | Acetophenone | The same as | The same as | The same as | The same as |
| | | above | above | above | above |
| Example 13 | Arachadic acid | The same as | The same as | The same as | The same as |
| | | above | above | above | above |
| Example 14 | Methyl caporate | The same as | The same as | The same as | The same as |
| | | above | above | above | above |
| Example 15 | 3,7-dimethyl-2,6- | The same as | The same as | The same as | The same as |
| | octadienal | above | above | above | above |
| Example 16 | Allyl isothiocyanate | The same as | The same as | The same as | The same as |
| | | above | above | above | above |
| Example 17 | Beta-myrcene | The same as | The same as | The same as | The same as |
| | | above | above | above | above |
| Example 18 | Eugenol | The same as | The same as | The same as | The same as |
| | | above | above | above | above |
| Example 19 | 1-octadecanol | The same as | The same as | The same as | The same as |
| | | above | above | above | above |
| Example 20 | 1-octanol | The same as | The same as | The same as | The same as |
| | | above | above | above | above |
| Example 21 | Allyl isothiocyanate | The same as | The same as | The same as | The same as |
| | | above | above | above | above |
| Example 22 | Ethyl heptanoate | 5 wt parts of | The same as | The same as | The same as |
| | | acrylic resin/5 wt | above | above | above |
| | | parts of rosin | | | |
| Example 23 | Cis-3-hexenyl-acetoate | The same as | The same as | The same as | The same as |
| | | above | above | above | above |
| Example 24 | Methyl caporate | The same as | The same as | The same as | The same as |
| | | above | above | above | above |
| Example 25 | Beta-myrcene | The same as | The same as | The same as | The same as |
| | | above | above | above | above |
| Example 26 | Eugenol | The same as | The same as | The same as | The same as |
| | | above | above | above | above |

### EXAMPLE 27

### Preparation of Booster-Containing Paint

Zinc pyrithione as a booster was added to a mixture of the same composition as in Example 14, thus preparing an antifouling paint. The addition of the booster was performed together with the pigment before the dispersion step.

### EXAMPLE 28

### Preparation of Paint Containing Mixture of Antifouling Substances

An antifouling paint was prepared in the same manner as in Example 15 except that dioctyl phthalate was substituted for half of the antifouling substance.

### COMPARATIVE EXAMPLE 1

An antifouling paint was prepared in the same manner as in Example 10 except that the antifouling substance was used in an amount of 1 wt part.

### COMPARATIVE EXAMPLE 2

An antifouling paint was prepared in the same manner as in Example 11 except that the antifouling substance was used in an amount of 1 wt part.

### COMPARATIVE EXAMPLE 3

An antifouling paint was prepared in the same manner as in Example 13 except that the antifouling substance was used in an amount of 1 wt part.

### TEST EXAMPLE 1

Three samples for each antifouling paint, prepared by treating KSD 3501 rolled steel sheets (300×300×3.2 mm) according to the KSM 5569 method, were coated with tar/vinyl resin for rust prevention. Then, each of the samples was spray-coated with each of the antifouling paints prepared in Examples 10-28 and Comparative Examples 1-3 to a dry thickness of 150 μm.

The coated panels were dried at 75% RH and 25° C. for 1 week, and then, immersed in an area with a water depth of 2 m in the Korean east sea. After 12 months, the panels were observed. The arithmetic mean of the fouling areas of the three samples was calculated for an effective area of 52,000 mm2 defined by a line at a distance of 70 mm downward from the upper edge of the samples, a line at a distance of 30 mm upward from the lower edge, and a line at a distance of 20 mm inward from each of both side edges. The calculated arithmetic mean was expressed in a unit of 5%, and the results are shown in Table 26 below.

TABLE 26

| | Fouling area (%) | | |
|---|---|---|---|
| | Slime | Algae | Barnacle |
| Example 10 | 0 | 0 | 0 |
| Example 11 | 5 | 0 | 0 |
| Example 12 | 15 | 5 | 0 |
| Example 13 | 5 | 5 | 0 |
| Example 14 | 0 | 0 | 0 |
| Example 15 | 5 | 0 | 0 |
| Example 16 | 0 | 0 | 0 |
| Example 17 | 10 | 5 | 0 |
| Example 18 | 0 | 0 | 0 |
| Example 19 | 15 | 5 | 0 |
| Example 20 | 0 | 0 | 0 |
| Example 21 | 0 | 0 | 0 |
| Example 22 | 0 | 0 | 0 |
| Example 23 | 5 | 0 | 0 |
| Example 24 | 0 | 0 | 0 |
| Example 25 | 5 | 0 | 0 |
| Example 26 | 10 | 0 | 0 |
| Example 27 | 0 | 0 | 0 |
| Example 28 | 0 | 0 | 0 |
| Comparative Example 1 | 100 | 100 | 50 |
| Comparative Example 2 | 100 | 100 | 60 |
| Comparative Example 3 | 100 | 100 | 65 |

As can be seen from the above results, the inventive antifouling paints have equal or higher antifouling performance than that of the existing antifouling paints containing organic tin compounds.

### TEST EXAMPLE 2

A liquid medium obtained by diluting PAGS by two-fold serial dilution was placed on a 96-multiwell plate and inoculated with 10⁴ cfu/ml of microorganisms. The liquid medium was incubated at 30° C. for 48 hours, and then, the minimum inhibitory concentration (MIC) of PAGS was measured by visually determining the growth or non-growth of the microorganisms on the basis of the medium turbidity. The liquid medium used in the test was a nutrient broth (Difco). The antibiotic substance used in the test was PAGS-1, and the test results are shown in Table 27.

TABLE 27
Measurement results for MIC of PAGS against
microorganisms

| MIC | |
|---|---|
| Staphylococcus | Aspergillus |
| aureus | niger |

| | 1:0 | 3:1 | 1:0 | 3:1 |
|---|---|---|---|---|
| Ethyl heptanoate | 4 | 4 | 10 | 8 |
| Cis-3-hexenyl-acetoate | 4 | 3 | 10 | 6 |
| Acetophenone | 4 | 3 | 10 | 6 |
| Arachadic acid | 4 | 3 | 10 | 6 |
| Methyl caporate | 4 | 5 | 10 | 6 |
| 3,7-dimethyl-2,6-octadienal | 4 | 3 | 10 | 5 |
| Allyl isothiocyanate | 4 | 3 | 10 | 5 |
| Beta-myrcene | 4 | 3 | 10 | 5 |
| Eugenol | 4 | 2 | 10 | 5 |
| 1-octadecanol | 4 | 4 | 10 | 7 |
| 1-octanol | 4 | 5 | 10 | 8 |
| Allyl isothiocyanate | 4 | 2 | 10 | 5 |

### INDUSTRIAL APPLICABILITY

As can be seen from the foregoing, the environment friendly antifouling agent according to the present invention is harmless to environment, has antifouling activity against a broad spectrum of fouling organisms, can be extracted from nature, resulting in a reduction in production cost, and can effectively prevent the pollution of marine environment caused by the use of toxic antifouling agents, such as TBT.

1-8. (canceled)

9. An antifouling agent for use in seawater containing as active ingredients at least one compound selected from the following agents:
at least one ketone compound selected from the group consisting of cis-3-haxenyl acetate, acetophenone, arachadic acid, methyl caproate and ethyl heptanoate;
at least one vinyl compounds selected from the group consisting of beta-myrcene and eugenol; and
at least one alcohol compound selected from the group consisting of 1-octadecanol and 1-octanol.

10. An environmental friendly antifouling paint for use in seawater comprising a resin, a solvent, a pigment, an antifouling substance and other additives, in which the antifouling substance is one or a mixture of two or more selected from the group consisting of 3,7-dimethyl-2,6-octadienal, cis-3-haxenyl acetate, acetophenone, arachadic acid, methyl caproate, ethyl heptanoate, allyl isothiocyanate, beta-myrcene, eugenol, 1-octadecanol and 1-octanol.

11. The antifouling paint for use in seawater of claim 10, wherein the content of the resin is 2-20% by weight.

12. The antifouling paint for use in seawater of claim 10, wherein the content of the solvent is 10-30% by weight.

13. The antifouling paint for use in seawater of claim 10, wherein the content of the antifouling substance is 3-40% by weight.

14. The antifouling paint for use in seawater of claim 10, which additionally contain a booster for increasing antifouling performance in an amount of 1-7% by weight, the booster being at least one selected from the group consisting of zinc pyrithione, copper pyrithione, polyhexamethylguanidine phosphate, 2,4,5,6-terachloroisophthalonitrile, 3,4-dichlorophenyl)-1,1-dimethylurea, 2-methylthio-4-terbutylamino-6-cyclopropylamino-s-triazine, zinc ethylenebisdithiocarbamate, manganese ethylenebisdithiocarbamate, 2-n-octyl-4,5-dichloro-2-methyl-4-isothiazoline-3-one, thiocyanomethylthio)benzothiazole, 2,3,5,6-2,3,5,6-tetrachloro-4-(methylsulphonyl)pyridine, 3-iodo-2-propynyl butylcarbamate, diiodomethyl-p-tolylsulfone, 1,2-benzoisothiazolin-3-one, 2-methylthio-4-tert-butylamino-6-cyclopropylamino-s-triazine, 2-(4-thiocyanomethylthio)benzothiazole, 2-n-octyl-4-isothiazolin-3-one, N-(fluorodichloromethylthio)-phthalimide, N-dichlorofluoromethylthio-N′,N′-dimethyl-N-p-tolylsulfamide, N,N-dimethyl-N′-phenyl-(fluorodichloromethylthio)-sulphamide, zinc(2-pyridylthio-1-oxide), copper(2-pyridylthio-1-oxide) and silver compounds.

15. The antifouling paint for use in seawater of claim 10, wherein the content of the other additives is 1-5% by weight.

16. A biocide containing as active ingredients at least one compounds selected from the following compounds:
at least one ketone compound consisting of the group consisting of cis-3-haxenyl acetate, acetophenone, arachadic acid, methyl caproate and ethyl heptanoate;
at least one vinyl compound selected from the group consisting of beta-myrcene and eugenol; and
1-octadecanol.
